(19) United States
(12) Patent Application Publication
(10) Pub. No.: US 2023/0242810 A1
(43) Pub. Date: Aug. 3, 2023

(54) TRIBOLUMINESCENT MATERIAL, USE OF A Cu COMPLEX AS A TRIBOLUMINESCENT MATERIAL, MECHANORESPONSIVE SENSOR AND METHOD FOR DETECTING A MECHANICAL LOADING

(71) Applicant: OKINAWA INSTITUTE OF SCIENCE AND TECHNOLOGY SCHOOL CORPORATION, Kunigami-gun, Okinawa (JP)

(72) Inventors: Julia KHUSNUTDINOVA, Kunigami-gun, Okinawa (JP); Ayumu KARIMATA, Kunigami-gun, Okinawa (JP); Pradnya Hukumchand PATIL, Kunigami-gun, Okinawa (JP)

(21) Appl. No.: 18/004,951

(22) PCT Filed: Jul. 12, 2021
(86) PCT No.: PCT/JP2021/026068

§ 371 Date: Jan. 10, 2023

(30) Foreign Application Priority Data
Jul. 13, 2020 (JP) 2020-120094

(51) Int. Cl. C09K 11/06; C09K 11/02; C07F 1/08; G01N 21/70

(52) U.S. Cl. CPC C09K 11/06; C09K 11/02; C07F 1/08; G01N 21/70; C09K 2211/188; C09K 2211/1044; C09K 2211/1029

(57) ABSTRACT

Triboluminescent materials that generate emission of light in response to mechanical stimulus attract significant attention due to their applications in development of “smart materials” and damage sensors. Among metal complexes, rare-earth europium and terbium complexes are most widely used, while there is no systematic data on triboluminescence in more readily available and inexpensive Cu complexes, with only a few scattered examples reported in the literature. We report a new family of photoluminescent Cu—NHC complexes that show bright triboluminescence (TL) in crystal state visible even in ambient light under air upon grinding or crushing the crystalline sample. Moreover, when these complexes are dispersed into amorphous polymethylmethacrylate (PMMA) films even at small concentrations, TL is easily observed. In Cu-containing polymer films, surrounding gas discharge is likely involved in excitation of brightly luminescent Cu—NHC complexes. Observation of TL in polymer films overcomes limitations of using crystalline phase for mechanoresponse and opens up possibilities for development of mechanoresponsive coatings and materials based on inexpensive metals such as Cu.

### TECHNICAL FIELD

The present invention relates to triboluminescence of Cu complexes with an N-heterocyclic carbene ligand (Cu—NHC complexes) in crystal state and polymer films. Particularly, the present invention relates to a triboluminescent material, use of a Cu complex, a mechanoresponsive sensor, a method for detecting a mechanical loading, a method for designing a Cu complex and a program for designing a Cu complex.

### BACKGROUND ART

Triboluminescence (TL), which is also called as mechanoluminescence (ML) or fractrolumminescence (FL), has been known as a generation of light emission from organic or inorganic materials caused by mechanical stimulus such as crushing, rubbing, or grinding. This phenomenon was first recorded in 1605 by Francis Bacon who reported light emission from scraping hard sugar (NPL 1).^{[1]} Currently TL attract significant attention due to application in the development of damage sensors in materials (NPL 2).^{[2]} Among known TL coordination compounds, complexes of rare earth elements, Eu^{III} and Tb^{III}, are most widely known (NPL 3).^{[3]} However, a limited number of transition metal (TM) complexes have been reported showing TL properties, including Mn^{II},^{[4]} Ru^{II},^{[5]} Pt^{II},^{[6]} and Cu^{I[7]} complexes (NPL 4-6, NPL 7, NPL 8, NPL 9).

### CITATION LIST

### Non Patent Literature

NPL 1: N. I. Korotkikh, V. S. Saberov, A. V. Kiselev, N. V. Glinyanaya, K. A. Marichev, T. M. Pekhtereva, G. V. Dudarenko, N. A. Bumagin, O. P. Shvaika, Chem. Heterocycl. Compd. (N. Y.) 2012, 47, 1551-1560.
NPL 2: F. Bottino, M. Di Grazia, P. Finocchiaro, F. R. Fronczek, A. Mamo, S. Pappalardo, J. Org. Chem. 1988, 53, 3521-3529.
NPL 3: C.-M. Che, Z.-Y. Li, K.-Y. Wong, C.-K. Poon, T. C. W. Mak, S.-M. Peng, Polyhedron 1994, 13, 771-776.
NPL 4: F. A. Cotton, D. M. L. Goodgame, M. Goodgame, J. Am. Chem. Soc. 1962, 84, 167-172;
NPL 5: S. Balsamy, P. Natarajan, R. Vedalakshmi, S. Muralidharan, Inorg. Chem. 2014, 53, 6054-6059;
NPL 6: J. Chen, Q. Zhang, F.-K. Zheng, Z.-F. Liu, S.-H. Wang, A. Q. Wu, G.-C. Guo, Dalton Trans. 2015, 44, 3289-3294.
NPL 7: G. L. Sharipov, A. A. Tukhbatullin, J. Lumin. 2019, 215, 116691.
NPL 8: C.-W. Hsu, K. T. Ly, W.-K. Lee, C.-C. Wu, L.-C. Wu, J.-J. Lee, T.-C. Lin, S.-H. Liu, P.-T. Chou, G.-H. Lee, Y. Chi, ACS Appl. Mater. Interfaces 2016, 8, 33888-33898.
NPL 9: L. J. Farrugia, J. Appl. Crystallogr. 2012, 45, 849-854.

### SUMMARY OF INVENTION

### Technical Problem

Considering that among these examples, Cu is one of the most abundant and inexpensive metals, TL materials based on Cu present a practical alternative to currently utilized Eu— and Tb-based materials. Using inexpensive metals such as copper may help to overcome difficulties associated with high cost and limited availability of rare earth element-based materials and potentially will lead to significant technological developments in the area of triboluminescent damage sensors. Until now, only a few scattered examples of TL Cu complexes have been reported;^{[7]} however, in majority of cases no triboluminescent spectra or any other systematic experimental data were reported, with the exception of one report.^{[8]} There are currently no precedents for a large family of copper complexes showing TL properties that allows to study how variation of the ligand and the complex structure will affect TL properties.

### Solution to Problem

The present application includes the following inventions:
[1] A triboluminescent material comprising a Cu complex with an N-heterocyclic carbene ligand, a pyridinophane ligand and a counter anion.

In the present application, the term “triboluminescent material” is defined as a material that generates emission of light in response to mechanical stimulus. The mechanical stimuli includes mechanical stress, strain and deformation, and they are derived from a mechanical loading such as compression, tension, tensile strength, impact, sharing, bending, abrasion, torsion, scratching, crushing, rubbing, grinding and ultrasound. The triboluminescent materials do not need irradiation of excitation light, such as UV light, to emit light.
[2] The triboluminescent material according to [1], wherein the Cu complex is represented by the following formula (1):

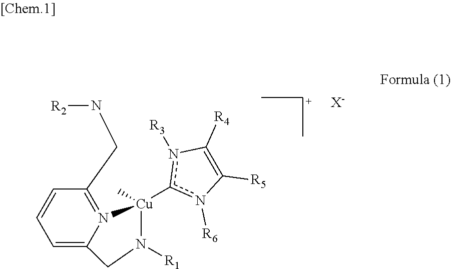

wherein R₁ and R₂ each represent a hydrogen atom or a substituent having 50 or less carbon atoms, preferably 10 or less carbon atoms, R₃ to R₆ each represent a hydrogen atom or a substituent, any pair of R₃ to R₆ are optionally taken together to form a ring, and at least one of the two pyridine rings is optionally substituted. X⁻ represents a counter anion.

Examples of the substituents for R₁ to R₆ include alkyl groups (preferably having 1 to 50 carbon atoms), alkenyl groups (preferably having 1 to 50 carbon atoms), alkynyl groups (preferably having 1 to 50 carbon atoms), alkoxy groups (preferably having 1 to 50 carbon atoms), nitro group, cyano group, halogen atoms, hydroxy group, thiol group, acyl groups (preferably having 1 to 50 carbon atoms), silyl groups (preferably having 1 to 50 carbon atoms), amino group, aldehyde group, isocyanate group, triazolyl groups, aryl groups (preferably having 6 to 50 carbon atoms), heterocycloalkyl groups (preferably having 3 to 50 carbon atoms), and heteroaryl groups (preferably having 3 to 50 carbon atoms). These exemplified groups may be further substituted. Such further substituted groups includes, for example, aralkyl groups, haloalkyl groups, alkoxysilyl groups. The substituents for R₁ to R₆ may have carboxyl bond, carboxyamide bond, ester bond, amide bond, sulfide bond, disulfide bond and the like.
[3] The triboluminescent material according to [2], wherein R₁ and R₂ are different from each other.
[4] The triboluminescent material according to [2] or [3], wherein R₁ and R₂ each represent a hydrocarbon group having 1 to 50 carbon atoms, preferably 1 to 10 carbon atoms.

In a preferred embodiment of the present application, R₁ is an unsubstituted alkyl group having 1 to 50 carbon atoms and R₂ is a group having an aromatic ring such as a substituted or unsubstituted aryl group having 6 to 50 carbon atoms or a substituted or unsubstituted aralkyl group having 7 to 50 carbon atoms.
[5] The triboluminescent material according to any one of claims [2] to [4], wherein R₄ and R₅ are taken together to form a ring.

In a preferred embodiment of the present application, R₄ and R₅ are taken together to form an aromatic ring.
[6] The triboluminescent material according to any one of claims [1] to [5], which is free from polymers.

The term “polymer” in the present application is defined as a compound having a unit recurring at least three times.
[7] The triboluminescent material according to any one of claims [1] to [5], which comprises a polymer.

The polymer may be polyurethane, polyester, polyamide, polylactone, polystyrene, polyacrylate, polymethacrylate, polyalkyleneoxide, polysiloxane, polydimethylsiloxane, polycarbonate, polylactide, polyolefin, polyisobutylene, polyamideimide, polybutadiene, epoxy resin, polyacetylene, and vinyl polymers.
[8] The triboluminescent material according to [7], wherein the Cu complex is not covalently incorporated into the polymer.

The Cu complex is not incorporated as a crosslinker into the polymer.
[9] The triboluminescent material according to [7], wherein the Cu complex is covalently incorporated into the polymer.

The Cu complexes discloses in Chem. Commun. 2020, 56, 50-53, which is incorporated herein by reference in its entirety, can be used in a triboluminescent material of the present invention.
[10] The triboluminescent material according to any one of [7] to [9], which comprises a crystalline fragment of the Cu complex.
[11] The triboluminescent material according to any one of claims [7] to [11], which is in the form of a film. The material may be in the form of a coating, particle, tablet, bead, or a fiber.
[12] Use of a Cu complex with an N-heterocyclic carbene ligand, a pyridinophane ligand and a counter anion as a triboluminescent material.
[13] Use of a composition comprising a polymer and a Cu complex with an N-heterocyclic carbene ligand, a pyridinophane ligand and a counter anion as a triboluminescent material.
[14] A mechanoresponsive sensor comprising the triboluminescent material of any one of claims [1] to [11].

In the present application, the term “mechanoresponsive sensor” is defined as a device that detects mechanical stimulus or mechanical damage and responds to it.
[15] A method for detecting a mechanical loading comprising:

determining a mechanoresponse of the triboluminescent material according to any one of claims [1] to [11] to the mechanical loading.

In the present invention, the mechanoresponse can be determined in air. In a preferred embodiment, the mechanoreponse is emission of visible light. In another preferred embodiment, the mechanoreponse is luminescence color change.
[16] A method for preparing the triboluminescent material according to any one of claims [7] to [11], comprising:

dissolving the Cu complex and the polymer in a solvent to prepare a solution, and drying the solution.
[17] A triboluminescent material prepared by the method according to [16].
[18] A method for designing a Cu complex, comprising:
1) evaluating triboluminescence of a Cu complex with an N-heterocyclic carbene ligand, a pyridinophane ligand and a counter anion, and
2) modifying at least one of the N-heterocyclic carbene ligand, the pyridinophane ligand and the counter anion to so design a new Cu complex as to improve triboluminescent property, and
3) optionally repeating 2) at least once.

By the method, color of emission, emission peak, maximum intensity and/or air stability can be optimized.
[19] A program for designing a Cu complex, performing the method according to [18].

### BRIEF DESCRIPTION OF DRAWINGS

FIG. 1 is a synthetic scheme of complexes 1, 2, and 3a-d.

FIG. 2 is normalized PL emission spectra of complexes 1, 2, and 3a-d (a) in the crystal state and (b) in PMMA films. Excitation at 380 nm.

FIG. 3 is representative images of TL in crystal of 1 (a), 2 (b) and 3a (c) under air and PMMA film containing 10 wt % of 1 (d), 2 (e), and 3a (f) under Ar.

FIG. 4 is normalized TL emission spectra of complexes 1, 2, and 3a-d (a) in the crystal state and (b) in PMMA films (1 wt %) under a nitrogen gas.

FIG. 5 is TL spectra of PMMA films containing 1 wt % of complexes (a) 1; (b) 2; and (c) 3a recorded under 1 atm of N₂, Ar, He, CO₂, and SF₆.

FIG. 6 is a graph showing PLQY of 1 wt % of 1, 2, and 3a in PMMA after exposing to air.

FIG. 7 is UV-vis absorption spectra of 1, 2, and 3a-d in dichloromethane at 25° C.

FIG. 8 is photograph of instrument for TL measurement.

FIG. 9 is full TL spectra of crystals of 1, 2, and 3a-d under a nitrogen gas atmosphere.

FIG. 10 is full TL spectra of PMMA films containing 1 wt % of 1, 2, and 3a-d under a nitrogen gas atmosphere.

FIG. 11 is TL spectra of crystalline samples of 1, 2, and 3a-d under an argon gas atmosphere.

FIG. 12 is TL spectra of PMMA films containing 1 wt % of 1, 2, and 3a-d under an argon gas atmosphere.

FIG. 13 is TL spectra of polystyrene films containing 1 wt % of 1, 2, and 3a under an argon gas atmosphere.

FIG. 14 is TL spectra of poly(vinyl chloride) films containing 1 wt % of 1, 2, and 3a under an argon gas atmosphere.

FIG. 15 is TL spectra of crystalline samples of (a) 1, (b) 2, and (c) 3a under varied gas atmosphere.

FIG. 16 is TL spectra of 3a in PMMA film with different weight ratio under argon: (a) 1 wt %; (b) 10 wt %; (c) 50 wt %; (d) 80 wt % of complex 3a; (e) overlay of normalized TL spectra.

FIG. 17 is TL spectra of PMMA films under vacuum of 0.5 Torr with 1 wt % of (a) 1; (b) 2; and (c) 3a.

FIG. 18 is pictures of triboluminescence of crystal of (a) 1; (b) 2; (c) 3a; (d) 3b; (e) 3c; and (d) 3d under air in ambient light.

FIG. 19 is pictures of PMMA films containing 10 wt % of 1 (left), 2 (center) and 3a (right) that were used for triboluminescence experiments.

FIG. 20 is an ORTEP diagram showing 50% probability anisotropic displacement ellipsoids of non-hydrogen atoms for compound 1 according to single crystal X-ray diffraction data.

FIG. 21 is an ORTEP diagram showing 50% probability anisotropic displacement ellipsoids of non-hydrogen atoms for compound 2 according to single crystal X-ray diffraction data.

FIG. 22 is an ORTEP diagram showing 50% probability anisotropic displacement ellipsoids of non-hydrogen atoms for compound 3b according to single crystal X-ray diffraction data. The second disordered component is shown by dashed lines.

FIG. 23 is an ORTEP diagram showing 50% probability anisotropic displacement ellipsoids of non-hydrogen atoms for compound 3c according to single crystal X-ray diffraction data. The second disordered component is shown by dashed lines.

FIG. 24 is an ORTEP diagram showing 50% probability anisotropic displacement ellipsoids of non-hydrogen atoms for compound 3d according to single crystal X-ray diffraction data. The second disordered component is shown by dashed lines.

### DESCRIPTION OF EMBODIMENTS

The contents of the invention will be described in detail below. The constitutional elements may be described below with reference to representative embodiments and specific examples of the invention, but the invention is not limited to the embodiments and the examples. In the present specification, a numerical range expressed by “from X to Y” means a range including the numerals X and Y as the lower limit and the upper limit, respectively. The invention relates to Japanese Patent Application No. 2020-120094 filed on Jul. 13, 2020, the disclosure of which is incorporated by reference herein in their entirety.

Triboluminescent Material

The triboluminescent material of the invention comprises a Cu complex with an N-heterocyclic carbene ligand, a pyridinophane ligand and a counter anion.

Cu Complex

The Cu complex of the triboluminescent material contains a complex ion and a counter anion. In the complex ion, N-heterocyclic carbene ligand and a pyridinophan ligand are coordinated with Cu.

The N-heterocyclic carbene ligand has a heterocycle containing a carbene carbon and two heteroatoms bonded to the carbene carbon, and is coordinated with Cu at the carbene carbon. And at least one of the two heteroatoms bonded to the carbene carbon is a nitrogen atom. When only one of the two heteroatoms is the nitrogen atom, the other heteroatom may be a sulfur atom or an oxygen atom. The heterocycle may contain another heteroatom as the ring member in addition to the two heteroatoms bonded to the carbene carbon.

Examples of the N-heterocyclic carbene ligand include a compound represented by the following formula (2).

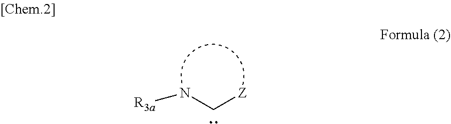

In the formula (2), Z represents>N-R₆ₐ, —O— (an oxygen atom) or —S— (a sulfur atom), and R₃ₐ and R₆ₐ each represent a hydrogen or a substituent. For the preferred ranges of the substituent for R₃ₐ and R₆ₐ, and specific examples thereof, the description for R₃ and R₆ of the following formula (1) may be referenced.

In the formula (2), the ring formed by the carbene carbon, N, Z and the dashed line is a heterocycle. The heterocycle may contain a heteroatom other than N and Z shown in the formula (2). The heterocycle may be a monocyclic ring or may be a fused ring in which the heterocycle containing the carbene carbon, N and Z are condensed with one or more rings. The ring that condenses with the heterocycle may be an aromatic ring or an aliphatic ring, and may be one containing a heteroatom as the ring member. When the heterocycle is a monocyclic ring, the number of ring members of the heterocycle is preferably 4 to 8, more preferably 4 to 6, and particularly preferably 5. When the heterocycle is a monocyclic ring, the number of carbon atoms (carbon atoms excluding the carbene carbon) in the heterocycle is preferably 1 to 4, more preferably 1 to 3, and particularly preferably 2. When the heterocycle is a fused ring, the number of ring members of the component ring containing the carbene carbon, N and Z is preferably 5 to 8, more preferably 5 or 6, particularly preferably is 5. The number of carbon atoms (carbon atoms excluding carbene carbon) in the entire fused ring is preferably 2 to 14, more preferably 2 to 10, further preferably 2 to 7. When the dashed line in the formula (2) contains at least one hydrogen atom, one or more of the hydrogen atoms may be substituted.

The pyridinophan ligand has two pyridine rings linked by two bridging structures and is coordinated with Cu at the nitrogen atom each of the two pyridine rings. The bridging structure is a divalent linking group that connects the carbon atom of one pyridine ring and the carbon atom of the other pyridine ring. The bridging structure may be a divalent atom or a divalent atomic group. A preferred example of the bridging structure is a linking group having a structure in which two substituted or unsubstituted alkylene groups are linked via an imino group (NR: R represents a hydrogen atom or a substituent). The bonding positions of the two pyridine rings to the two bridging structures are preferably 2—or 3-position of the first pyridine ring and 5—or 6-position of the second pyridine ring, and more preferably 2-position of the first pyridine ring and 6-position of the second pyridine ring. In the two pyridine rings, the hydrogen atoms at the positions not bonded to the bridging structure may be substituted with a substituent. Hereinafter, the nitrogen atom constituting the pyridine ring of the pyridinophan ligand is referred to as “pyridine nitrogen”, and the nitrogen atom constituting the bridging structure of the pyridinophan ligand is referred to as “bridge nitrogen”.

Examples of the pyridinophan ligand include a compound represented by the following formula (3).

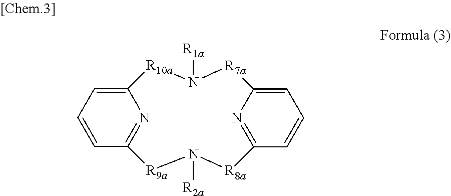

In formula (3), R₁ₐ, and R₂ₐ each represent a hydrogen atom or a substituent having 50 or less carbon atoms. For the descriptions for the substituent having 50 or less carbon atoms, the preferred ranges thereof and specific examples thereof, the description for the substituent having 50 or less carbon atoms capable of being on R₁ and R₂ of the following formula (1) may be referenced.

R₇ₐ to R₁₀ₐ each represent substituted or unsubstituted alkylene groups. The alkylene group may be linear or branched. The alkylene group preferably has from 1 to 3 carbon atoms, more preferably from 1 or 2, further preferably 1. Specific examples of the alkylene group include a methylene group, an ethylene group, and a propylene group. For the preferred ranges of the substituent that may be substituted on the alkylene group and specific examples thereof, the description for the substituent having 50 or less carbon atoms capable of being on R₁ and R₂ of the following formula (1) may be referenced.

In the formula (3), the hydrogen atoms of the two pyridine rings may be substituted. For the preferred ranges of the substituents that may substitute on the two pyridine rings and specific examples thereof, the description for the substituent having 50 or less carbon atoms capable of being on R₁ and R₂ of the following formula (1) may be referenced.

The counter anion in the Cu complex is a monovalent anion. For specific examples of counter anions, specific examples of X⁻ in the following formula (1) may be referenced.

The Cu complex is preferably represented by the following formula (1).

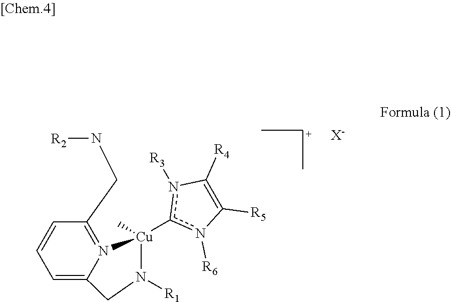

In the formula (1), R₁ and R₂ each represent a hydrogen atom or a substituent having 50 or less carbon atoms. R₁ and R₂ may be the same as or different from each other. The substituent having 50 or less carbon atoms may be a hydrocarbon group having from 1 to 50 carbon atoms or may be a substituent containing 1 or more heteroatoms and having 50 or less carbon atoms. Preferred substituents for R₁ and R₂ are a hydrocarbon groups having 1 to 10 carbon atoms.

R₃ to R₆ each represent a hydrogen atom or a substituent. R₃ to R₆ may be the same as or different from each other.

Examples of the substituent capable being on R₁ to R₆ include an alkyl group (preferably having 1 to 50 carbon atoms), an alkenyl group (preferably having 1 to 50 carbon atoms), an alkynyl group (preferably having 1 to 50 carbon atoms), an alkoxy group (preferably having 1 to 50 carbon atoms), a nitro group, a cyano group, a halogen atom, a hydroxy group, a thiol group, an acyl group (preferably having 1 to 50 carbon atoms), a silyl group (preferably having 1 to 50 carbon atoms), an amino group, an aldehyde group, an isocyanate group, a triazolyl group, an aryl group (preferably having 6 to 50 carbon atoms), a heterocycloalkyl group (preferably having 3 to 50 carbon atoms), and a heteroaryl group (preferably having 3 to 50 carbon atoms). These exemplified groups may be further substituted. Such further substitutable groups includes, for example, an aralkyl group, a haloalkyl group, an alkoxysilyl group. The substituents for R₁ to R₆ may have a carboxyl bond, a carboxyamide bond, an ester bond, an amide bond, a sulfide bond, a disulfide bond and the like. The number of carbon atoms contained in each of the substituents of R₁ and R₂ is 50 or less.

Among these substituents, the substituents for R₁ and R₂ are preferably a substituted or unsubstituted alkyl group, and more preferably an unsubstituted alkyl group. The alkyl group of “substituted or unsubstituted alkyl group” and “unsubstituted alkyl group” may be linear, branched or cyclic. The alkyl group have from 1 to 50 carbon atoms, preferably from 1 to 10 carbon atoms, more preferably from 1 to 6 carbon atoms, further preferably from 1 to 4 carbon atoms. Specific examples of the alkyl group include a methyl group (Me), an ethyl group, a n-propyl group (n-Pr), an isopropyl group (i-Pr), a n-butyl group, an isobutyl group, a sec-butyl group, and a tertbutyl group (t-Bu).

The substituents for R₃ and R₆ are preferably a group having an aromatic ring such as a substituted or unsubstituted aryl group and a substituted or unsubstituted aralkyl group. The aryl group of “substituted or unsubstituted aryl group” and the aryl group constituting “substituted or unsubstituted aralkyl group” may be a monocyclic ring or a fused ring. The aryl group and the aryl group constituting the aralkyl group preferably have from 7 to 50 carbon atoms, more preferably from 6 to 22 carbon atoms, further preferably from 6 to 18 carbon atoms, still further preferably from 6 to 10 carbon atoms. The alkyl group constituting the aralkyl group preferably have from 1 to 10 carbon atoms, more preferably from 1 to 6 carbon atoms, and further preferably 1 to 3 carbon atoms. Specific examples of the aryl group include a phenyl group and naphthyl group. Specific examples of the aralkyl group include a benzyl group and a naphthylmethyl group. Preferred examples of the substituents for the aryl group and the aralkyl group include an alkyl group. For the descriptions for the alkyl group, the preferred ranges thereof, and specific examples thereof, the descriptions for the alkyl group capable of being R₁ and R₂ above may be referenced. Among these, branched alkyl groups are preferred.

Any pair of R₃ to R₆ are optionally taken together to form a ring. For example, R₃ and R₄, R₄ and R₅, and R₅ and R₆ may be bonded to each other to form a ring together with one side of the imidazole ring. The ring may be an aromatic ring or an aliphatic ring, and may be one containing a hetero atom. The hetero atom herein is preferably selected from the group consisting of a nitrogen atom, an oxygen atom and a sulfur atom. Examples of the ring formed include a benzene ring, a naphthalene ring, and a pyridine ring. In a preferred embodiment of the invention, R₄ and R₅ are bonded to each other to form a ring, more preferably an aromatic ring, further preferably a benzene ring.

In the formula (1), at least one hydrogen atom in the two pyridine rings may be substituted. For the preferred ranges of the substituent that may be substituted on the two pyridine rings and specific examples thereof, the description for the substituent having 50 or less carbon atoms capable of being on R₁ and R₂ of the following formula (1) may be referenced.

In a preferred embodiment of the invention, R₁ and R₂ are an unsubstituted alkyl group having 1 to 50 carbon atoms and R₃ and R₆ are a group having an aromatic ring such as a substituted or unsubstituted aryl group having 6 to 50 carbon atoms or a substituted or unsubstituted aralkyl group having 7 to 50 carbon atoms.

In a preferred embodiment of the invention, at least one of R₁ to R₆ contains a branched alkyl group. In a more preferred embodiment of the invention, both R₁ and R₂ are branched alkyl groups, or both R₃ and R₆ contain an aryl groups substituted with one or more branched alkyl groups. When both R₁ and R₂ are branched alkyl groups, these branched alkyl groups may be the same as or different from each other. When both R₃ and R₆ contain aryl groups substituted with one or more branched alkyl groups, these branched alkyl groups may be the same as or different from each other.

In the formula (1), X⁻ represents a counter anion. The counter anion is a monovalent anion. Specific examples of the counter anion include the following anions.

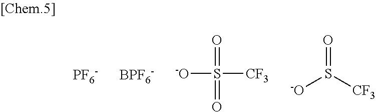

Specific examples of the Cu complex represented by the formula (1) are shown below. However, The Cu complex capable of being used in the invention is not construed as being limited to the specific examples.

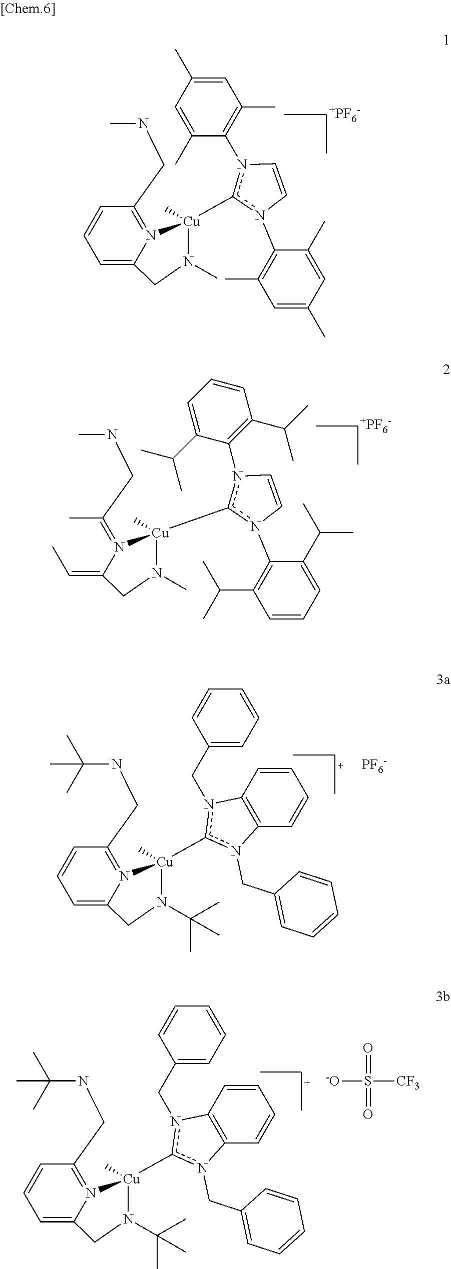

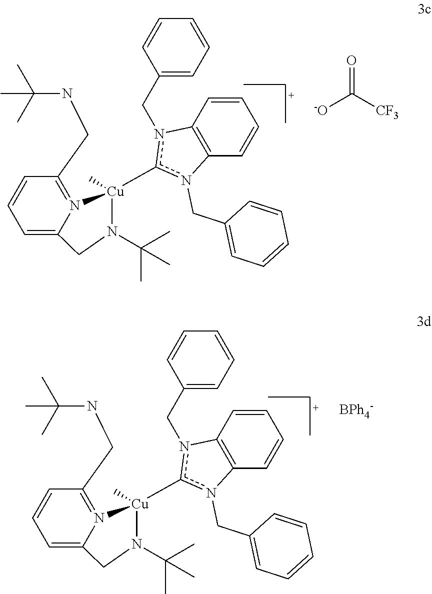

In a preferred embodiment of the invention, the triboluminescent material comprises a crystalline fragment of the Cu complex. It can be confirmed by X-ray diffraction analysis that the Cu complex forms crystals. In a preferred embodiment of the invention, the Cu complex is dispersed in a matrix material. For specific examples of the matrix material, specific examples of polymers in column of “Other components of the triboluminescent material” below may be referenced. The Cu complex used in the invention is preferably not incorporated into a polymer by a covalent bond, and particularly preferably not incorporated into a polymer as a cross-linking agent. For example, the Cu complex represented by the formula (1) preferably does not contain a polymer structure in R₁ to R₆, and more preferably does not contain a polymer structure in R₁ and R₂.

Other Components of the Triboluminescent Material

The triboluminescent material of the invention may contain only a Cu complex or may further contain other components. Examples of other components include a polymer. The term “polymer” in the present application is defined as a compound having a unit recurring at least three times, and the term “polymer structure” in the present application is defined as a structure having a unit recurring at least three times. The recurring unit referred to here is a structure derived from a monomer as a synthetic raw material for the polymer. In the case where the material contains the polymer, the moldability of the material is improved, and the triboluminescent material can be molded into various forms. Preferred shapes of the material include a film form and a coating form.

Examples of the polymer include polyurethane, polyester, polyamide, polylactone, polystyrene, polyacrylate, polymethacrylate, polyalkyleneoxide, polysiloxane, polydimethylsiloxane, polycarbonate, polylactide, polyolefin, polyisobutylene, polyamideimide, polybutadiene, epoxy resin, polyacetylene, and vinyl polymers. The polyacrylate is preferably a polyalkylacrylate, more preferably a polyalkylmethacrylate. The number of carbon atoms of the alkyl group of the polyalkylacrylate and the polyalkylmethacrylate is preferably from 1 to 10, more preferably from 1 to 6, further preferably from 1 to 3. The molecular weight of the polymer is not particularly limited and may be selected from, for example, the range of 1000 to 100000. These polymers may be used alone or in combination of two or more.

In the case where the triboluminescent material contains a polymer, the amount of the Cu complex in the triboluminescent material is preferably 0.01% by weight or more, more preferably 0.1% by weight or more, further preferably 1% by weight or more, and preferably 99% by weight or less, more preferably 50% by weight or less, further preferably 10% by weight by weight or less, each based on the total weight of the polymer.

Utility of Cu Complex and Composition Containing Complex

The Cu complex with an N-heterocyclic carbene ligand, a pyridinophane ligand and a counter anion of the invention is useful as a triboluminescent material because it emits light in response to a mechanical stimulus without being irradiated with excitation light such as UV light. The composition containing the Cu complex and a polymer is useful as a triboluminescent material because the Cu complex emits light in response to a mechanical stimulus when a mechanical stimulus is applied. The mechanical stimuli include mechanical stress, strain and deformation, and they are derived from a mechanical loading such as compression, tension, tensile strength, impact, sharing, bending, abrasion, torsion, scratching, crushing, rubbing, grinding and ultrasound. The environment for causing the triboluminescent material to emit light is not particularly limited. The triboluminescent material may be used in air or in an inert gas atmosphere.

Form of Triboluminescent Material

The form of the triboluminescent material may be appropriately selected depending on the application. Examples of the triboluminescent material form include films, sheets, coatings, particles, tablets, beads, or fibers. The size of the triboluminescent material may be appropriately selected depending on the application. For example, the thickness of the triboluminescent material in film and sheet form may be selected from the range of from 0.1 m to 10 cm.

Mechanoresponsive Sensor

The mechanoresponsive sensor of the invention comprises the triboluminescent material of the invention.

For the description for the triboluminescent material in the mechanoresponsive sensor of the invention, the description for the triboluminescent material above may be referenced.

When the sensor of the invention receives a mechanical stimulus or mechanical damage, the triboluminescent material contained in the sensor emits light in response to the stimulus. Therefore, by detecting the light emission or color change of the light emission, it is possible to easily detect the mechanical stimulus or the mechanical damage received by the sensor.

The sensor of the invention may have a sensitive unit containing the triboluminescent material of the invention and a light receiving unit that detects light generated in the sensitive unit and converts it into an analog voltage or a digital signal.

Method for detecting a mechanical loading.

The method for detecting a mechanical loading comprises a step of determining a mechanoresponse of the triboluminescent material of the invention.

In the present invention, the mechanoresponse can be determined in air. For the description for the triboluminescent material of the invention, the description for the triboluminescent material above may be referenced.

Examples of mechanical responses to mechanical loads of the triboluminescent material include light emission and changes in light (for example, change in intensity, wavelength or both). In a preferred embodiment, the mechanical response is the emission of visible light. In the present application, “visible light” means light with a wavelength of from 380 to 780 nm. In another preferred embodiment, the mechanical response is color change of luminescence (emission wavelength change). The color change may be a change from long-wavelength light to short-wavelength light, or may be a change from short-wavelength light to long-wavelength light. Examples of changes in emission color include changes between red (640 to 780 nm) and green (490 to 550 nm), changes between red and blue (380 to 490 nm), and changes between green and blue.

Method for Preparing the Triboluminescent Material

The method for preparing the triboluminescent material of the invention comprises a step of dissolving the Cu complex and the polymer in a solvent to prepare a solution, and drying the solution.

For the description for the triboluminescent material in the method of the invention, the description for the triboluminescent material above may be referenced. For the ratio of the Cu complex to the polymer in the solution, the corresponding description in the column of “Other components of the triboluminescent material” may be refenced.

Examples of the solvent include aromatics such as benzene, toluene, xylene and chlorobenzene; ethers such as diethyl ether, dibutyl ether, tetrahydrofuran, 1,4-dioxane, dimethoxyethane and diethylene glycol dimethyl ether; esters such as methyl acetate, ethyl acetate, butyl acetate and ethyl propionate; ketones such as acetone, methyl ethyl ketone, methyl isobutyl ketone and cyclohexanone; hydrocarbons such as hexane, heptane, octane and nonane; halogens such as dichloromethane, chloroform and 1,2-dichloroethane; hydrocarbons; organic acids such as formic acid, acetic acid and propionic acid; polar solvents such as N, N-dimethylformamide, N, N-dimethylacetamide and N-methylpyrrolidone; and water. These solvents or a mixture of these solvents may be appropriately selected and used for preparing a solution.

The drying temperature of the solution is not particularly limited. The solution may be dried in air or under a reduced pressure, and after being substantially dried in air, it may be further dried under a reduced pressure.

Further, the method of the invention may include a step of coating the prepared solution on a base material to form a coating film. Drying the coated solution provides a triboluminescent material in the form of film or coating. The coating method is not particularly limited, and a known wet process such as a casting method or a spin coating method may be appropriately selected and used.

Method for Designing a Cu Complex

A method for designing a Cu complex, comprises:
1) evaluating triboluminescence of a Cu complex with an N-heterocyclic carbene ligand, a pyridinophane ligand and a counter anion, and
2) modifying at least one of the N-heterocyclic carbene ligand, the pyridinophane ligand and the counter anion to so design a new Cu complex as to improve triboluminescent property, and
3) optionally repeating 2) at least once.

By the method, color of emission, emission peak, maximum intensity and/or air stability can be optimized.

In step 1), at least one of triboluminescence properties is evaluated. For example, emission color, emission peak, maximum intensity, and/or air stability may be evaluated.

In step 2), the modification may be made to any one of the N-heterocyclic carbene ligand, the pyridinophan ligand and the counter anion, any two of them, or all of them. Examples of modifications to the N-heterocyclic carbene ligand include changing the carbon number of the substituent, changing the type of the substituent, and introducing another substituent. Examples of modifications to the pyridinophan ligand include changing the carbon number of the substituent or the bridging structure, changing the type of the substituent, and introducing another substituent. Examples of modifications to the counter anion include changing the element constituting the anion to an element in the same element group, and changing the type of anion. For the options of the carbon number and type of the substituent, the carbon number and type of the bridging structure, and the type of anion, the descriptions for R₁ to R₆ and X⁻ of the formula (1) above and the descriptions for R₇ₐ to R₀ₐ of the formula (3) above may be referenced. Step 3) is performed as needed, and may or may not be performed. When step 3) is performed, the number of times step 2) is repeated may be once or twice or more. According to this method, the emission color, emission peak, maximum intensity and/or air stability can be optimized.

Program

The program of the present invention is for designing a Cu complex by executing the method for designing a Cu complex of the present invention.

For each step that constitutes the program, the description of each step of the Cu complex design method can be referred to.

### Example 1

In this work, we report a new family of air-stable Cu N-heterocyclic carbene (NHC) complexes showing TL properties not only in the crystalline state, but also when blended into a polymethylmethacrylate, polystyrene, and poly(vinyl chloride) films. Bright emission can be seen even in ambient light upon grinding the crystals under air. These compounds significantly expand currently known library of TL copper complexes. These properties make these complexes suitable for development of stress or damage sensors in composite or polymer materials using Cu as an abundant and cheap metal.

Recently, we have reported a series of photoluminescent (PL) and air-stable Cu—NHC complexes containing N4 pyridinophane ligand, which can be cross-linked into polybutylacrylate films.^{[9]} The resulting Cu-containing polymers enable sensitive detection and visualization mechanical stress, leading to reversible changes in PL intensity when the flexible film is being stretched or released under UV light irradiation. During the study of stimuli-responsive properties of these complexes, we found that several N4-containing Cu—NHC complexes exhibit bright TL visible even in ambient light under air upon crushing or grinding the crystals. To further investigate the TL properties of these complexes, we synthesized a series of [(^{R}N4)Cu(NHC)]X complexes with variable counter anion X, ^{R}N4 and NHC ligands (1, 2, and 3a-d). Those six Cu complexes showed TL properties in a crystalline state and in polymer films.

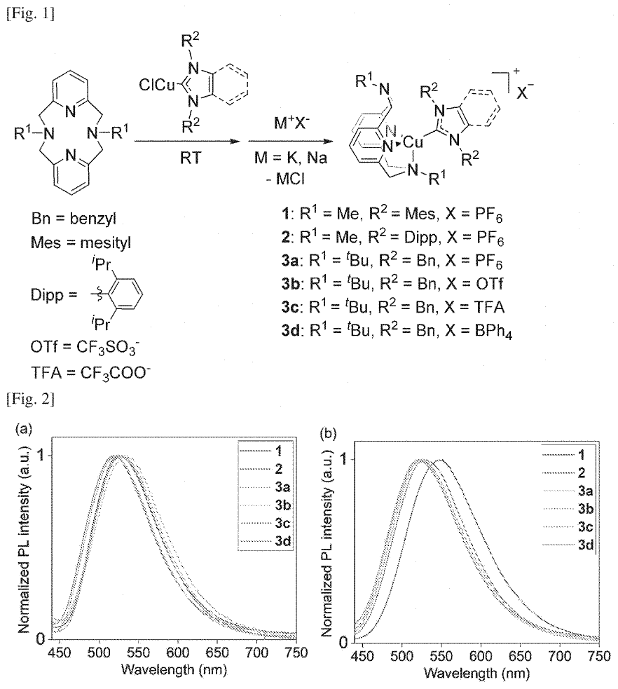

Complexes 1, 2, and 3a-d were easily prepared by mixing ^{R}N4 pyridinophane ligand (R=^{t}Bu or Me) and (NHC)CuCl, followed by a counter anion exchange at ambient temperature. All complexes were isolated in 49-93% yields and characterized by NMR, X-ray diffraction (XRD), elemental analysis, UV-vis and IR spectroscopies. XRD study confirmed distorted tetrahedral geometry around the Cu center with NHC, two pyridines and one amine of ^{R}N4 ligand bound to Cu (FIG. 1).

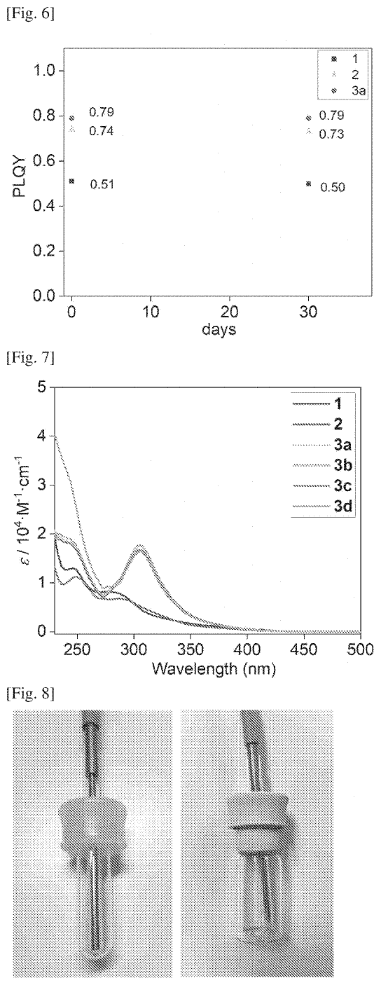

All complexes show high photoluminescence quantum yield (PLQY) in the solid state (0.66-0.83) (Table 1 and FIG. 2). We have also prepared polymethylmethacrylate (PMMA) films containing 1 wt % of all Cu complexes by dissolving required amount of the complex in PMMA/CH₂Cl₂ solution and drying films under vacuum. The PMMA films containing Cu complexes showed good PLQYs (0.51-0.79) and air stability showing no decrease in PLQY after 30 days in air (FIG. 6).

TABLE 1
Photophysical properties of complexes 1, 2 and 3a-d in the solid
state and in PMMA films (1 wt %) under a nitrogen gas at 298 K.^{[a]}

| | |
|---|---|
| Crystal state | PMMA film |

| | λₘₐₓ | | λₘₐₓ | |
|---|---|---|---|---|
| Complex | [nm]^{[b]} | ϕ^{[c]} | [nm]^{[b]} | ϕ^{[c]} |
| 1 | 527 | 0.66 | 547 | 0.51 |
| 2 | 518 | 0.83 | 528 | 0.74 |
| 3a | 528 | 0.76 | 522 | 0.79 |
| 3b | 532 | 0.79 | 521 | 0.78 |
| 3c | 522 | 0.74 | 527 | 0.58 |
| 3d | 525 | 0.77 | 521 | 0.77 |

^{[a]}Excitation at 380 nm.
^{[b]}Emission maximum.
^{[c]}PLQY.

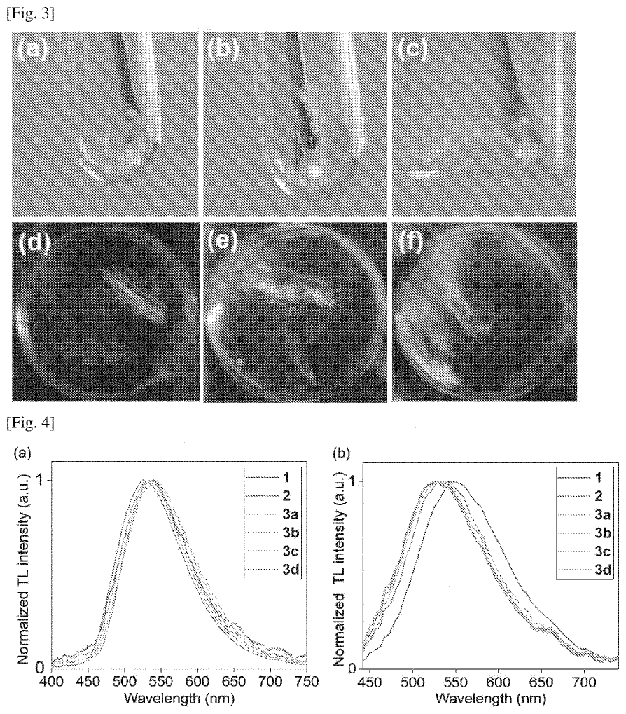

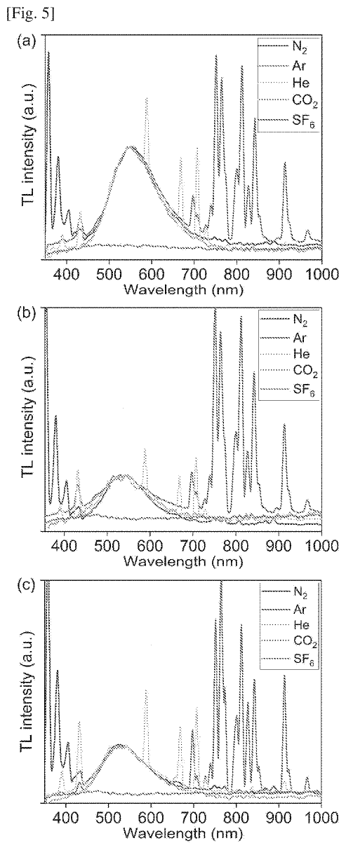

Crystals of 1, 2, and 3a-d were found to generate intense emission upon grinding the crystalline sample with stainless steel spatula or glass rod, or when the single crystals are compressed between glass plates, visible even in ambient light under air (FIG. 3, ac). To obtain TL spectra, crystals of 1, 2, and 3a-d were placed in glass vial and ground by glass tube containing a fiber optic probe in a nitrogen gas atmosphere. The obtained TL spectra are shown in FIG. 4. High speed camera recording give in the SI of the single crystal compression shows generation of emission along the cracks.

### Example 2

Furthermore, we then explored if TL properties can also be observed when these triboluminescent Cu(NHC) complexes were physically blended into polymer films. Utilizing polymer films may provide a convenient way to make bulk mechanoresponsive material or coating via simple synthetic methods. The films were prepared by dissolving a powder of polymethylmethacrylate (PMMA) and 1 wt % of a Cu complex in dichloromethane, then casted on a glass Petri dish or a glass vial followed by slow evaporation and drying under vacuum that gave transparent hard films. The analogous procedure was used to prepare polystyrene and poly(vinyl chloride) films.

We found that TL was observed in polymer films upon rubbing the surface with a glass rod or metal spatula under a nitrogen gas atmosphere (FIG. 3, d-f). Compared to TL of the crystalline samples, TL of polymer films was less intense presumably due to low Cu content, but it is clearly visible by eye in the dark or ambient light under inert atmosphere. Thus, these finding represent the first example of the Cu complexes showing TL properties when blended into polymer films.

### Example 3

We also recorded TL spectra under atmosphere of various gases including N₂, Ar, He, CO₂, and SF₆. The TL in PMMA films containing complexes 1, 2, and 3a were not observed under air, but was observed in N₂, Ar, and He. Interestingly, in addition to a broad emission peak of the copper complexes observed in TL spectra of all samples, additional sharp emission peaks were clearly seen at 358, 380, and 405 nm when TL spectrum was recorded under N₂ atmosphere, characteristic of an electric discharge through N₂ gas. The representative TL spectra for complexes 1, 2, and 3a dispersed in PMMA film recorded under 1 atm of different gases are shown in FIG. 5. Accordingly, in Ar and He atmosphere, emission peaks were observed corresponding to the line spectrum an electric discharge through the corresponding gases. Under CO₂ gas and under vacuum (0.5 Torr), the emission spectra show only TL of Cu complexes without gas the discharge spectrum (with exception of complex 2, which showed N₂ discharge peaks at 0.5 Torr). TL was not observed under SF₆ atmosphere.

In summary, we report a new family of six Cu(NHC) complexes showing bright triboluminescence both in the crystal state and when blended or dispersed into polymer films. These findings also significantly expand the library of known TL complexes of copper, an earth abundant and inexpensive metal. The ability to utilize solution cast polymer films significantly expands the range of possible applications of such TL materials for visualization of applied mechanical force and damage sensing in materials. Currently we are investigating the scope of luminophres and polymers that can be used to prepare triboluminescent polymer films to develop a general approach to observing visible triboluminescence in polymers under a variety of mechanical stimuli.

### [Table 2]

### REFERENCES

[1] (a) J. I. Zink, Acc. Chem. Res. 1978, 11, 289-295; (b) P. Jha, B. P. Chandra, Luminescence 2014, 29, 977-993; (c) Y. Xie, Z. Li, Chem 2018, 4, 943-971.
[2] (a) I. Sage, G. Bourhill, J. Mater. Chem. 2001, 11, 231-245; (b) X. Wang, H. Zhang, R. Yu, L. Dong, D. Peng, A. Zhang, Y. Zhang, H. Liu, C. Pan, Z. L. Wang, Adv. Mater. 2015, 27, 2324-2331; (c) D. O. Olawale, K. Kliewer, A. Okoye, T. J. Dickens, M. J. Uddin, O. I. Okoli, J. Lumin. 2014, 147, 235-241; (d) S. Mukherjee, P. Thilagar, Angew. Chem. Int. Ed. 2019, 58, 7922-7932.
[3] (a) J.-C. G. Bünzli, K.-L. Wong, J. Rare Earth 2018, 36, 1-41; (b) Y. Hirai, T. Nakanishi, Y. Kitagawa, K. Fushimi, T. Seki, H. Ito, Y. Hasegawa, Angew. Chem. Int. Ed. 2017, 56, 7171-7175; (c) C. R. Hurt, N. McAvoy, S. Bjorklund, N. Filipescu, Nature 1966, 212, 179-180.
[4] (a) F. A. Cotton, D. M. L. Goodgame, M. Goodgame, J. Am. Chem. Soc. 1962, 84, 167-172; (b) S. Balsamy, P. Natarajan, R. Vedalakshmi, S. Muralidharan, Inorg. Chem. 2014, 53, 6054-6059; (c) J. Chen, Q. Zhang, F.-K. Zheng, Z.-F. Liu, S.-H. Wang, A. Q. Wu, G.-C. Guo, Dalton Trans. 2015, 44, 3289-3294.
[5] G. L. Sharipov, A. A. Tukhbatullin, J. Lumin. 2019, 215, 116691.
[6] C.-W. Hsu, K. T. Ly, W.-K. Lee, C.-C. Wu, L.-C. Wu, J.-J. Lee, T.-C. Lin, S.-H. Liu, P.-T. Chou, G.-H. Lee, Y. Chi, ACS Appl. Mater. Interfaces 2016, 8, 33888-33898.
[7] (a) D. M. Knotter, M. D. Janssen, D. M. Grove, W. J. J. Smeets, E. Horn, A. L. Spek, G. Van Koten, Inorg. Chem. 1991, 30, 4361-4366; (b) D. M. Knotter, H. L. Van Maanen, D. M. Grove, A. L. Spek, G. Van Koten, Inorg. Chem. 1991, 30, 3309-3317; (c) F. Marchetti, C. Di Nicola, R. Pettinari, I. Timokhin, C. Pettinari, J. Chem. Educ. 2012, 89, 652-655; (d) D. M. Knotter, G. Blasse, J. P. M. Van Vliet, G. Van Koten, Inorg. Chem. 1992, 31, 2196-2201; (e) D. M. Knotter, A. L. Spek, D. M. Grove, G. Van Koten, Organometallics 1992, 11, 4083-4090; (f) C. Pettinari, C. di Nicola, F. Marchetti, R. Pettinari, B. W. Skelton, N. Somers, A. H. White, W. T. Robinson, M. R. Chierotti, R. Gobetto, C. Nervi, Eur. J. Inorg. Chem. 2008, 1974-1984.
[8] A. Incel, C. Varlikli, C. D. McMillen, M. M. Demir, J. Phys. Chem. C 2017, 121, 11709-11716.
[9] A. Karimata, P. H. Patil, E. Khaskin, S. Lapointe, R. R. Fayzullin, P. Stampoulis, J. R. Khusnutdinova, Chem. Commun. 2020, 56, 50-53.

### EXPERIMENTAL SECTION

### I. General Specifications

Materials. (1,3-dibenzylbenzimidazoyl-2-ylidene)copper(I) chloride,¹

N,N′-dimethyl-2,11-diaza[3,3](2,6)pyridinophane,²

N,N′-di-tert-butyl-2,11-diaza[3,3](2,6)pyridinophane³, complex 3a⁴ were synthesized by the previously reported procedures. Powder of polymethylmethacrylate (PMMA) (Mw: 350,000), polystyrene (Mw: 35,000), and poly(vinyl chloride) (Mw: 48,000) were purchased from Aldrich.

Chloro[1,3-bis(2,4,6-trimethylphenyl)imidazol-2-ylidene]copper(I) and

chloro[1,3-bis(2,6-diisopropylphenyl)imidazol-2-ylidene]copper(I) were purchased from Tokyo Chemical Industry.

Instrumentation. NMR spectra were measured on JEOL ECZ600R or JEOL ECZ400S NMR spectrometers. The following abbreviations are used for describing NMR spectra: s (singlet), d (doublet), t (triplet), dd (double of doublets), quat (quaternary). Electrospray Ionization Mass Spectrometry (ESI-MS) measurements were performed on a Thermo Scientific ETD apparatus. Elemental analyses were performed using an Exeter Analytical CE440 instrument. FT-IR spectra were measured using an Agilent Cary 630 with an ATR module in an argon-filled glovebox. The following abbreviations are used for describing FT-IR spectra: s (strong), m (medium), w (weak), br (broad). Absorbance UV/vis spectra were collected using an Agilent Cary 60 instrument.

Photoluminescence properties. Luminescence spectra and luminescence quantum yields were recorded by a Hamamatsu Quantaurus-QY Plus spectrometer (excitation wavelength is 380 nm). For PLQY measurements, a solid sample placed on a quartz dish was purged with nitrogen gas for 30 min and measured keeping nitrogen gas flow (excitation wavelength is 380 nm).

Measurement of triboluminescence spectra in Ar. In a glove box filled with Ar gas, crystals or PMMA films in glass tube or glass vial were rubbed by a glass tube (diameter: 9.0 mm) in which a fiber optic probe was placed inside. The TL spectra were collected using QE-Pro 6200 spectrometer manufactured by Ocean Optics (integration time is 5 seconds).

Measurement of triboluminescence spectra under atmosphere of different gases including carbon dioxide, nitrogen, helium, and sulfur hexafluoride. Glass tube or vial containing crystals or PMMA films were capped with septum, through which a glass tube (diameter: 9.0 mm) was inserted; a fiber optic probe was placed inside a glass tube. Prior to measurement, a gas was purged for 5 minutes through the needle. During measurement, the setup was protected from stray light by covering in aluminum foil. Samples were crushed or rubbed by the glass tube under a gas flow. The generated light was collected by QE-Pro 6200 spectrometer manufactured by Ocean Optics (integration time is 5 seconds).

High speed camera video recording. A phantom v641 with a 105 mm Nikon macro lens was used. The f-stop was 2.8. Frame rate of 2000 or 5000 fps was applied. During experiments, crystals were crushed between two glass microscope slides. The emission imaging was obtained by free software ImageJ (1.52a).

### II. Synthesis of Cu complexes

### Synthesis of Complex 1

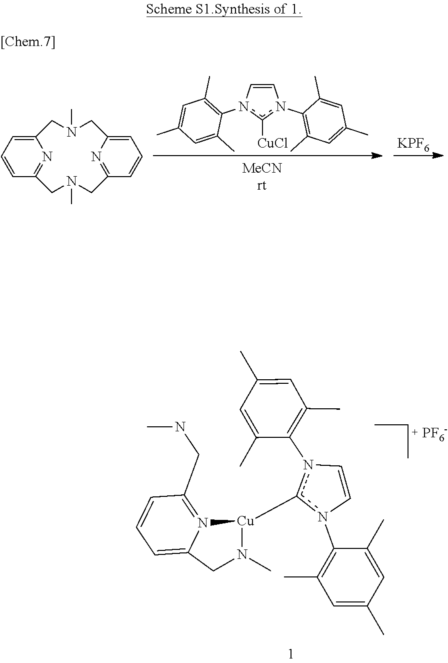

In a glovcbox, N,N′-dimethyl-2,11-diaza[3,3](2,6)-pyridinophanc (100 mg, 0.373 mmol), chloro[1,3-bis(2,4,6-trimethylphenyl)imidazol-2-ylidene]copper(I) (150 mg, 0.372 mmol). KPF₆ (688 mg, 3.74 mmol), and dry McCN (10 mL) were placed in 20 mL vial and stirred at room temperature for 2 h. After reducing volume of solvent to ca. 1 mL under reduced pressure, dichloromethane (2 mL) was added and the reaction mixture was filtered off to remove insoluble white solid. Crystals of pure compound were then obtained by diethyl ether vapor diffusion to dichloromethane solution at least three times to provide yellow crystalline solid (278 mg, 96%). A crystal suitable for X-ray crystallography and tribolumincsccncc study was obtained by vapor diffusion with MeCN-diethyl ether.

¹H NMR (600 MHz, −30° C., CD₂Cl₂): δ7.24 (t, ³J_{HH-}=7.6 Hz, p-H_{py}, 2H), 7.17 (s, CHₜₘ, 2H), 6.90 (s, CH_{Mes-Ar}, 4H), 6.72 (d, ³J_{HH}=7.6 Hz, m-H_{py}, 2H), 6.63 (d, ³J_{HH}=7.6 Hz, m-H_{py}, 2H), 3.55 (d, ²J_{HH}=15.3, Py—CH₂—N,2H), 3.48 (s, Py—CH₂—N, 4H), 3.32 (d, ²J_{HH}=15.3 Hz, Py—CH₂—N, 2H), 2.34 (s, N—CH₃, 3H), 2.30 (s, N—CH₃, 3H), 2.25 (s, C—CH_{3Mes-Ar}, 6H), 2.14 (s, C—CH_{3Mes-Ar}, 12H).

¹³C NMR (151 MHz, −30° C., CD₂Cl₂): δ186.3 (quat. Cₜₘ), 154.6 (quat. C_{Py}), 153.9 (quat. C_{Py}), 138.6 (Nₜₘ-C_{Mes-Ar}), 136.4 (p-C_{Py}), 135.99 (p-C(CH₃)_{Mes-Ar}), 134.7 (o-C(CH₃)_{Mes-Ar}, 128.8 (CH_{Mes-Ar}), 123.7 (m-C_{Py}), 121.7 (CHₜₘ), 121.2 (m-C_{Py}), 65.8 (Py—CH₂—N), 64.5 (Py—CH₂—N), 49.8 (N-CH₃), 43.6 (N-CH₃), 20.7 (C(CH₃)_{Mes-Ar}), 18.2 (—C(CH₃)_{Mes-Ar},

¹⁹F NMR (376 MHz, CD₂Cl₂): δ−73.5 (d, J_{P,F}=714 MHz). EST-HRMS m/z calcd for [C₃₇H₄₄CuN₆]⁺=635.2923, found: 635.2901, and [PF₆]144.9647, found: 144.9659

Elemental Analysis. Found (caled for C₃₇H₄₄N₆CuF₆P): C, 57.16 (56.88), H, 5.96 (5.68), N, 10.50 (10.76).

UV-vis (in dichloromethane): λ, nm (ε, M⁻¹cm⁻¹) 228 (20000), 278 (8200).

### Synthesis of Complex 2

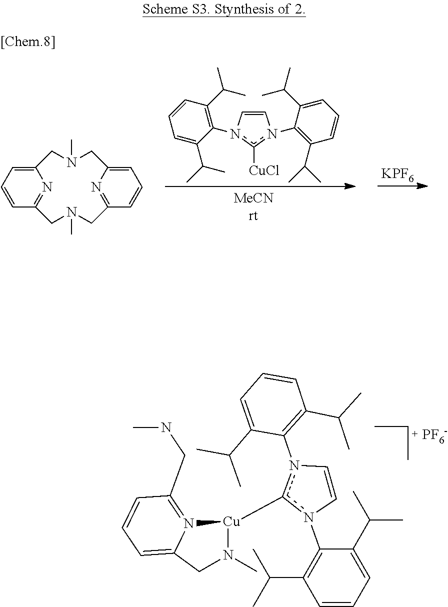

Complex 2 was prepared by the same procedure as 1 using N,N′-dimemethyl-2,11-diaza[3,3](2,6)-pyridinophane (81.4 mg, 0.303 mmol), chloro[1,3-bis(2,6-diisopropylphenyl)imidazol-2-ylidene]copper(I) (147 mg, 0.301 mmol), MeCN (8 mL), and KPF₆ (556 mg, 3.02 mmol) to provide yellow crystalline solid (239 mg, 92%). Crystals suitable for X-ray crystallography and triboluminescence study were obtained by the vapor diffusion method with dichloromethane-diethyl ether.

¹H NMR (400 MHz, CD₂Cl₂): δ7.44 (t, ³J_{HH}=7.9 Hz, Ar—H_{IPf}, 2H), 7.30 (s, CHₜₘ, 2H), 7.31 (t, ³J_{HH}=7.7 Hz, p-H_{Py}, 2H), 7.23 (d, ³J_{HH}=7.9 Hz, Ar—H_{IPr}, 4H), 6.69 (d, ³J_{HH} 7.7 Hz, m-H_{Py}, 2H), 6.68 (d, ³J_{HH}=7.7 Hz, m-H_{Py}, 2H), 3.72 (d, ²J_{HH}=14.3 Hz, Py—CH₂—N, 2H), 3.59 (d, ²J_{HH}=15.4 Hz, Py—CH₂—N, 2H), 3.50 (d, ²J_{HH}=14.3 Hz, Py—CH₂—N, 2H), 3.38 (d, ²J_{HH}=15.4 Hz, Py—CH₂—N, 2H), 3.17 (septet, ³J_{HH}=6.8 Hz, CH(CH₃)₂, 4H), 2.24 (s, N—CH₃, 3H), 2.14 (s, N—CH₃, 3H), 1.13 (d, ³J_{HH}=6.8 Hz, CH(CH₃)₂, 12H), 1.00 (d, ³J_{HH}=6.8 Hz, CH(CH₃)₂, 12H).

¹³C NMR (100 MHz, CD₂Cl₂): δ186.3 (quat. Cₜₘ), 155.0 (quat. C_{Py}), 154.2 (quat. C_{Py}), 145.8 (quat. CM), 137.0 (p-C_{Py}) and (CH_{Imd}), 130.5 (p-CM), 124.7 (m-CM), 123.8 (m-C_{Py}), 123.7 (CM-C(CH₃)₂), 121.7 (121.4 (m-C_{Py}), 66.3 (Py—CH₂—N), 63.4 (Py—CH₂—N), 51.9 (N-CH₃), 38.9 (N-CH₃), 29.1 (CH(CH₃)₂), 25.8 (CH(CH₃)₂), 21.8 (CH(CH₃)₂). ¹⁹F NMR (376 MHz, CD₂Cl₂): −73.4 (d, J_{P,F},=714 MHz).

ESI-HRMS m/z calcd for [C₄₃H₅₆CuN₆]⁺=719.3862, found: 719.3833, and [PF₆]⁻=144.9647, found: 144.9665

Elemental analysis. Found (calcd for C₄₃H₅₆N₆CuPF₆) C, 59.51 (59.68), H, 6.80 (6.52), N, 9.40 (9.71) UV-vis (in dichloromethane): λ, nm (ε, M⁻¹cm⁻¹) 228 (15000), 287 (6700).

### Synthesis of complex 3b

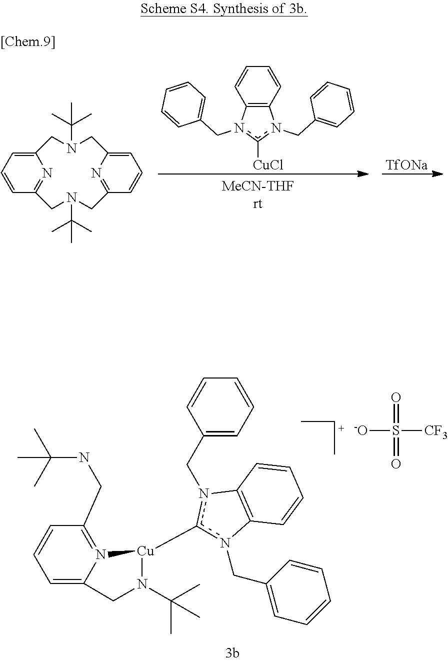

Complex 3b was prepared by the similar procedure as 1 using 1,3-bis(2,6-dibenzylbenzimidazoyl-2)-ylidene)copper(I) chloride (57.6 mg, 0.145 mmol), N,N′-di-t-buty1-2,11-diaza[3,3](2,6)-pyridinophane (50.1 mg, 0.142 mmol), dry McCN (1 mL), dry THF (1 mL), and sodium trifluoromethanesulfonate (76.3 mg, 0.443 mmol) to provide yellow crystalline solid (60.1 mg, 49%). Crystals suitable for X-ray crystallography and tribolumincsccnce study were obtained by solvent diffusion method with dichloromethane-benzene.

¹H NMR (400 MHz, CD₂Cl₂): δ 7.32-7.25 (m, p-Hₚ, and Ar—H_{benz}, 12H), 7.06-7.03 (m, Ar—H_{benz}, 4H), 6.81 (d, ³J_{HH}=7.8 Hz, m-H_{py}, 2H), 6.77 (d, ³J_{HH}=7.5 Hz, m-H_{py}, 2H), 6.08 (d, ²J_{HH}=16.1 Hz, CH_{2benz}, 2H), 5.65 (d, ²J_{HH}=16.1 Hz, CH_{2benz}, 2H), 4.73 (d, ²J_{HH}=15.1 Hz, Py—CH₂—N, 2H), 3.76 (d, ²J_{HH}=12.8 Hz, Py—CH₂—N, 2H), 3.60 (d, ²J_{HH}15.1 Hz, Py—CH₂—N, 2H), 3.50 (d, ²J_{HH}=12.8 Hz, Py—CH₂—N, 2H), 1.36 (s, N—C(CH₃)₃, 9H), 1.02 (s, N—C(CH₃)₃, 9H).

¹³C NMR (100 MHz, CD₂Cl₂): δ192.7 (quat. C_{Imd}), 160.0 (quat. C_{Py}), 155.4 (quat. C_{Py}), 137.6 (p-C_{Py}), 136.2 (Ar—C-_{benz}), 134.6 (Ar—C-_{benz}), 129.0 (Ar—CH-_{benz}), 127.9 (Ar—C-_{benz}), 126.3 (Ar—CH_{benz}), 124.3 (m-C_{Py}), 123.8 (Ar—CH-_{benz}), 121.7 (m-C_{Py}), 112.2 (Ar—CH-_{benz}), 59.7 (Py—CH₂—N), 59.2 (Py—CH₂—N), 59.1 (Py—CH₂—N), 56.3 (N—C(CH₃)₂), 52.3 (CH_{2benz}), 27.5 (N—C(CH₃)₃).

¹⁹F NMR (376 MHz, CD₂Cl₂): δ−88.3 (s).

ESI-HRMS m/z calcd for [C₄₃H₅₀CuN₆]⁺=713.3393, found: 713.3371, and [CF₃SO₃]=148.9526, found: 148.9548.

Elemental Analysis. Found (calcd for C₄₄H₅₀N₆CuO₃SF₃): C, 61.05 (61.20), H, 5.58 (5.84), N, 9.62 (9.73).

UV-vis (in dichloromethane): λ, nm (ε, M⁻¹cm⁻¹) 230 (20000), 305 (17000).

### Synthesis of complex 3c

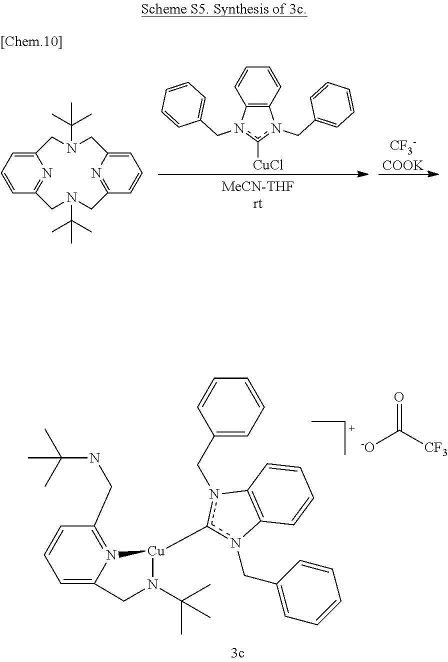

n a glovebox, (1,3-dibenzylbenzimidazoyl-2-ylidene)copper(I) chloride (56.8 mg, 0.143 mmol), N,N′-di-t-bulyl-2,11-diaza[3,3](2,6)-pyridinophane (50.1 mg, 0.142 mmol), dry McCN (1 mL), and dry THF (1 mL) were stirred at room temperature for 2 h. Potassium trifluoroacelale (46.1 mg, 0.303 mmol) was dissolved in dry MeOH (3 mL) and added to the mixture. After stirring for 10 min, the reaction mixture was concentrated under reduced pressure. The obtained solid was suspended in dry dichloromethane (2 mL), then filtered off to remove insoluble white solid and concentrated under reduced pressure. Diethyl ether vapor diffusion into dichloromethane solution gave yellow crystalline solid. The crystals were washed with diethyl ether. The obtained yellow crystal was further purified by crystallization with the vapor diffusion method using dichloromethane-diethyl ether at least three times to give yellow crystals suitable for X-ray crystallography and triboluminescence study.(90.5 mg, 77%).

The obtained yellow crystal was further purified by crystallization with the vapor diffusion method using dichloromethane-diethyl ether at least three times to give yellow crystals suitable for X-ray crystallography and triboluminescence study.(90.5 mg, 77%).

¹H NMR (400 MHz, CD₂Cl₂): δ 7.33-7.28 (m, p-H_{py}, and Ar—H_{benz}, 12H), 7.06-7.03 (m, Ar—H_{benz}, 4H), 6.82 (d, ³J_{HH}=7.8 Hz, m-H_{py}, 2H), 6.77 (d, ³J_{HH}=7.5 Hz, m-H_{py}, 2H), 6.08 (d, ²J_{HH}=16.1 Hz, CH_{2benz}, 2H), 5.66 (d, ²J_{HH}=16.1 Hz, CH_{2benz}, 2H), 4.73 (d, ²J_{HH}=15.1 Hz, —Py—CH₂—N—, 2H), 3.76 (d, ²J_{HH}=13.0 Hz, Py—CH₂—N, 2H), 3.61 (d, ²J_{HH}15.1 Hz, Py—CH₂—N, 2H), 3.50 (d, ²J_{HH}=13.0 Hz, Py—CH₂—N, 2H), 1.36 (s, N—C(CH₃)₃, 9H), 1.02 (s, N—C(CH₃)₃, 9H).

¹³C NMR (100 MHz, CD₂Cl₂): δ192.7 (quat. C_{Imd}), 160.0 (quat. C_{Py}), 155.5 (quat. C_{Py}), 137.6 (p-C_{Py}), 136.2 (Ar—C-_{benz}), 134.6 (Ar—C-_{benz}), 129.0 (Ar—CH-_{benz}), 127.9 (Ar—C-_{benz}), 126.3 (Ar—CH_{benz}), 124.2 (m-C_{Py}), 123.8 (Ar—CH-_{benz}), 121.7 (m-C_{Py}), 112.2 (Ar—CH-_{benz}), 59.7 (Py—CH₂—N), 59.1 (Py—CH₂—N), 56.3 (N—C(CH₃)₂), 52.3 (CH_{benz}), 27.5 (N—C(CH₃)₃).

¹⁹F NMR (376 MHz, CD₂Cl₂): δ−74.7 (s).

ESI-HRMS m/z calcd for [C₄₃H₅₀CuN₆]⁺=713.3393, found: 713.3371, and [CF₃CO₂]=112.9856, found: 112.9876.

Elemental Analysis. Found (calcd for C₄₅H₅₀N₆CuO₂F₃): C, 65.05 (65.32), H, 6.20 (6.09), N, 10.08 (10.16).

UV-vis (in dichloromethane): λ, nm (ε, M⁻¹ cm⁻¹) 230 (20000), 305 (17000).

### Synthesis of 3d

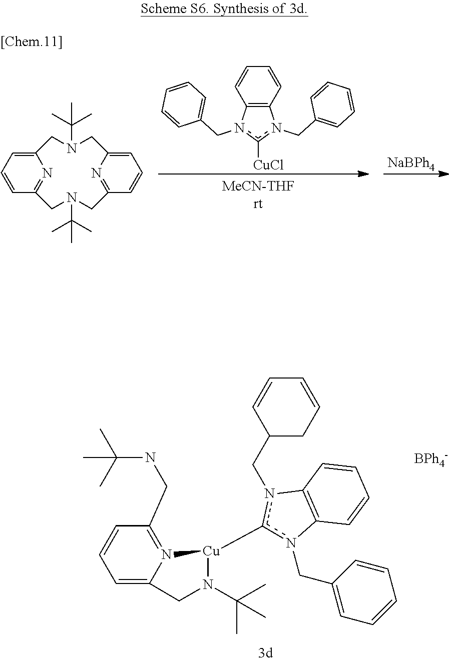

In a glovebox, (1,3-dibenzylbenzimidazoyl-2-ylidene)copper(I) chloride (57.1 mg, 0.144 mmol), N,N′-di-t-butyl-2,11-diaza[3,3](2,6)-pyridinophane (50.5 mg, 0.143 mmol), dry McCN (1 mL), and dry THF (1 mL) were stirred at room temperature for 2 h. NaBPh₄ (98.8 mg, 0.289 mmol) was dissolved in dry MeOH (3 mL) and added to the mixture. After stirring for 10 min, the reaction mixture was concentrated under reduced pressure, then suspended in a mixture of dry dichloromcthanc (1 mL) and dry MeCN (1 mL), then filtered off to remove white solid. Yellow crystalline solid was obtained by diethyl ether diffusion into the resulting solution. The obtained crystalline solid were collected and further purified by crystallization by diethyl ether diffusion to acetone solution three times to provide crystals suitable for X-ray crystallography and triboluminescence study (92.9 mg, 63%).

¹H NMR (400 MHz, CD₂Cl₂): δ 7.34-7.25 (m, p-H_{py} Ar-H_{benz}, and B-m-Hₚₕ, 20H), 7.07-7.04 (m, Ar—H_{benz}, 4H), 7.01 (t, B-o-Hₚₕ, 8H), 6.86, (t, B-p-Hₚₕ, 4H), 6.77 (d, ³J_{HH}=7.8 Hz, m-H_{Py}, 2H), 6.85 (d, ³J_{HH}=7.5 Hz, m-H_{Py}, 2H), 6.08 (d, ²J_{HH}=16.0 Hz, CH_{2benz}, 2H), 5.66 (d, ²J_{HH}=16.0 Hz, CH_{2benz}, 2H), 4.70 (d, ²J_{HH}=14.6 Hz, Py—CH₂—N, 2H), 3.77 (d, ²J_{HH}=12.8 Hz, Py—CH₂—N, 2H), 3.51 (d, ²J_{HH}=12.4 Hz, Py—CH₂—N, 2H), 3.49 (d, ²J H_{H}=15.1 Hz, Py—CH₂—N, 2H), 1.37 (s, N—C(CH₃)₃, 9H), 1.00 (s, N—C(CH₃)₃, 9H).

¹³C NMR (100 MHz, CD₂Cl₂): δ192.6 (quat. CₜₘA), 164.9-163.4 (B-Cᵢₚₛₒ), 160.1 (quat. C_{Py}), 155.2 (quat. C_{Py}), 137.6 (p-C_{Py}), 136.1 (B-o-Ph), 135.9 (Ar—C-_{benz}), 134.4 (Ar—C-_{benz}), 129.0 (Ar—CH-_{benz}), 128.0 (Ar—C-_{benz}), 126.3 (Ar—CH_{benz}), 125.7 (B-m-Ph), 124.4 (m-C_{Py}), 123.9 (Ar—CH-_{benz}), 121.8 (B-p-Ph), 121.6 (m-C_{Py}), 112.2 (Ar—CH-_{benz}), 59.6 (Py—CH₂—N), 59.2 (Py—CH₂—N), 59.1 (Py—CH₂—N), 56.3 (N—C(CH₃)₂), 52.3 (CH_{2benz}), 27.5 (N—C(CH₃)₃).

ESI-HRMS m/z calcd for [C₄₃H₅₀CuN₆]⁺=713.3393, found: 713.3376, and [C₂₄H₂₀B]=319.1664, found: 319.1682.

Elemental Analysis. Found (caled for C₆₇H₇₀N₆BCu) C, 77.81 (77.85), H, 6.80(6.83), N, 8.16 (8.13).

UV-vis (in dichloromethane): λ, nm (ε, M⁻¹ cm⁻¹) 230 (40000), 305 (16000)

### Preparation of PMMA films containing Cu(I) complexes

In a glove box, Cu(I) complex (2 mg), was added to a solution of PMMA (200 mg) in dry dichloromethane (2.5 mL) in a glass vial containing a magnetic stirring bar; the reaction mixture was stirred until complete dissolution. The solution was evaporated slowly under reduced pressure in a vial or a glass Petri dish, then further dried under vacuum at room temperature for 1 day. The obtained film was carefully removed and used for characterization of photophysical properties. PMMA films containing different ratio of Cu(I) complexes to PMMA were prepared with the same method by altering the ratio of Cu(I) complex.

Air stability of 1, 2, and 3a in PMMA films

The PMMA films containing 1 wt % of Cu (I) complexes (1, 2, and 3a) were placed in the glass vials and kept in air at ambient temperature. The samples were purged with a nitrogen gas for 1 hour prior to measuring PLQY in integrating sphere. The PLQYs were measured under a nitrogen gas flow and were determined as an average of measurements for the three films.

See FIG. 6.

### III. UV-vis spectra of Cu complexes

See FIG. 7.

### IV. Triboluminescent properties

Crystals or PMMA films were put in glass vial or glass tube equipped with septum. A glass tube in which optical probe is placed was inserted through septum. Prior to measurement, gases were purged for 5 minutes through needle. The crystals or PMMA films were crushed or rubbed under gas flow.

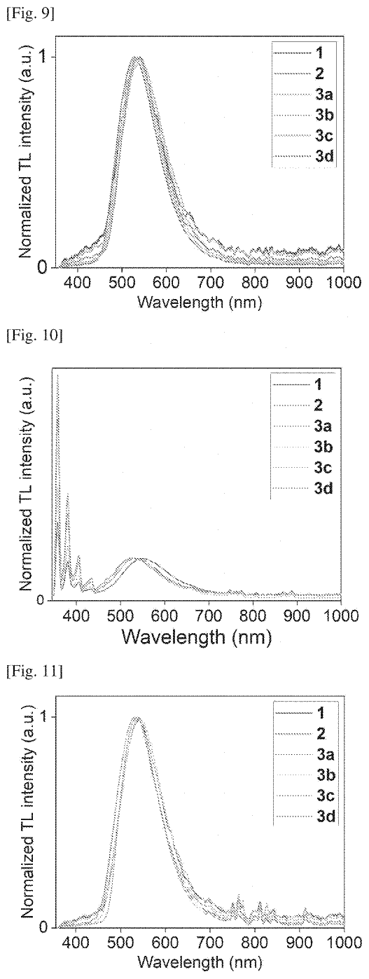

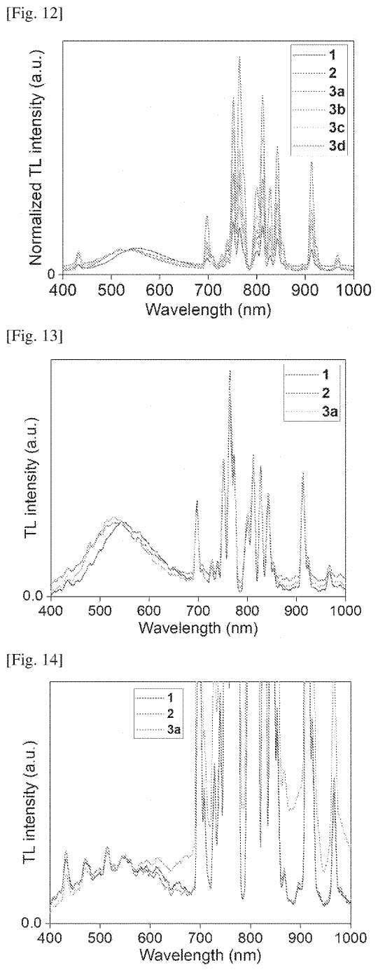

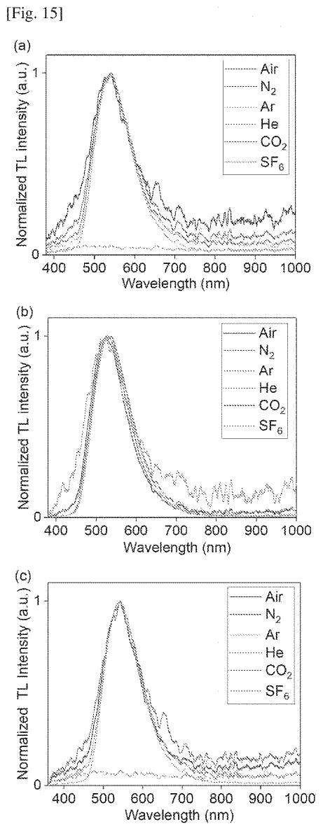

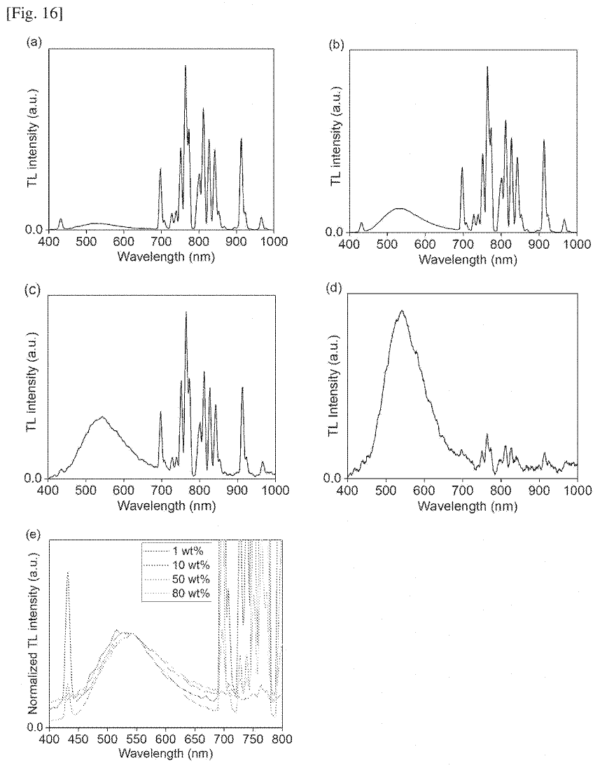

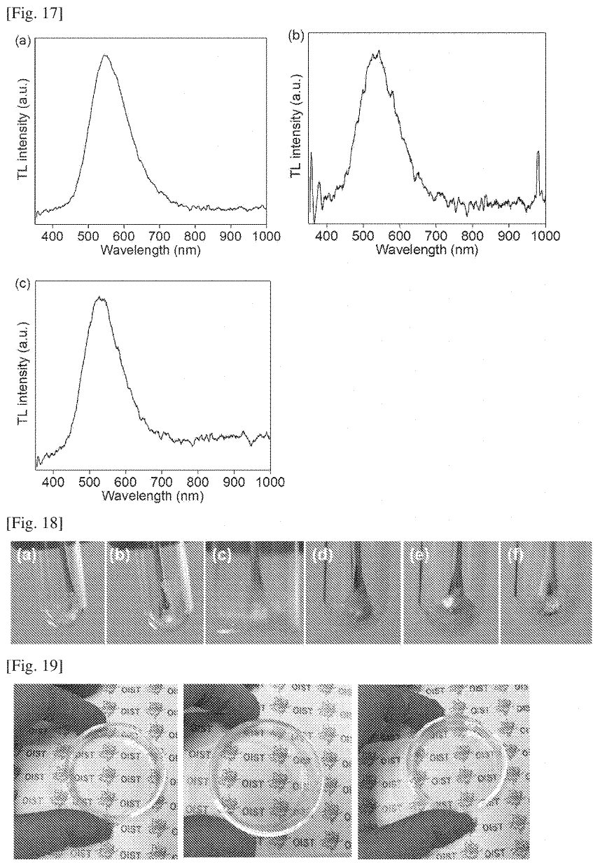

See FIG. 8 to 19.

### V. X-ray structure determination details

The X-ray diffraction data for the single crystals 1, 2, and 3b-d were collected on a Rigaku XtaLab PRO instrument in an o-scan mode with a PILATUS3 R 200K hybrid pixel array detector and MicroMax™-003 microfocus X-ray tubes using MoKα (0.71073 Å) and CuKα (1.54184 Å) radiation monochromated by means of multilayer optics. The performance mode of the X-ray tubes was 50 kV, 0.60 mA. The diffractometer was equipped with a Rigaku GN2 system for low temperature experiments. Suitable crystals of appropriate dimensions were mounted on loops in random orientations. The data were collected according to recommended strategies in an o-scan mode. Final cell constants were determined by global refinement of reflections from the complete data sets using the Lattice wizard module. Images were indexed and integrated with “smart” background evaluation using the CrysAlis^{Pro} (versions 1.171.39.7b-1.171.40.79a) data reduction package. Analysis of the integrated data did not show any decay. Data were corrected for systematic errors and absorption using the ABSPACK module: Numerical absorption correction based on Gaussian integration over a multifaceted crystal model and empirical absorption correction based on spherical harmonics according to the point group symmetry using equivalent reflections. The GRAL module and the ASSIGN SPACEGROUP routine of the WinGX suite were used for the analysis of systematic absences and space-group determination. All structures were solved by the direct methods using SHELXT-2018/2⁵ and refined by the full-matrix least-squares on F² using SHELXL-2018/3,⁶ which uses a model of atomic scattering based on spherical atoms. Calculations were mainly performed using the WinGX-2018.3 suite of programs.⁷ Non-hydrogen atoms were refined anisotropically. The hydrogen atoms were inserted at the calculated positions and refined as riding atoms. The positions of the hydrogen atoms of methyl groups were found using rotating group refinement with idealized tetrahedral angles. The disorder, if present, was resolved using free variables and reasonable restraints on geometry and anisotropic displacement parameters. All the compounds studied have no unusual bond lengths and angles. Absolute crystal structure of complexes 2 and 3b-c was determined on the basis of the Flack parameter.⁸

Deposition numbers 2009593-2009597 contain the supplementary crystallographic data for this paper. These data are provided free of charge by the joint Cambridge Crystallographic Data Centre and Fachinformationszentrum Karlsruhe Access Structures service www.ccdc.cam.ac.uk/structures.

### Crystallographic data for 1

C₃₇H₄₄CuN₆+F₆P×0.5 C₄H₁₀O, yellow prism (0.248×0.218×0.158 mm³), formula weight 818.35; monoclinic, P2ₜ/n (No. 14), a=11.46796(15) Å, b=19.4563(2) Å, c=17.9268(3) Å, β=106.3314(15°), V=3838.52(9) Å³, Z=4, Z′=1, T=103(2) K, d_{calc}=1.416 g cm⁻³, μ(MoKα)=0.679 mm⁻¹, F(000)=1708; T_{max/min}=1.000/0.401; 111295 reflections were collected (2.093°≤θ'32.347°, index ranges: −16≤h≤17, −29≤k≤27, −26≤1≤26), 12827 of which were unique, Rᵢₙₜ=0.0308, Rₒ=0.0183; completeness to θₘₐₓ 93.5%. The refinement of 515 parameters with 27 restraints converged to R₁=0.0321 and wR₂=0.0867 for 11273 reflections with I>2σ(I) and R₁=0.0380 and wR₂=0.0892 for all data with S=1.060 and residual electron density, ρ_{max/min}=1.018 and −0.475 e Å⁻³. The crystals were grown by vapor diffusion in an acetonitrile-diethyl ether system at r.t.

### Crystallographic data for 2

C₄₃H₅₆CuN₆⁺F₆P×CH₂Cl₂, yellow prism (0.248×0.185×0.087 mm³), formula weight 950.37; orthorhombic, P2₁2₁2₁ (No. 19), a=12.1264(7) Å, b=18.4915(15) Å, c=19.9843(14) Å, V=4481.2(5) Å³, Z=4, Z′'² 1, T=95(2) K, d_{calc}=1.409 g cm⁻³, μ(MoKα)=0.706 mm⁻¹, F(000)=1984; T_{max/min}=1.000/0.591; 41059 reflections were collected (1.964°≤θ≤27.648°, index ranges: −15≤h≤15, −23≤k≤21, ≤26≤1≤24), 10348 of which were unique, Rᵢₙₜ=0.0350, Rₒ=0.0314; completeness to θₘₐₓ 99.7%. The refinement of 551 parameters with no restraints converged to R₁=0.0308 and wR₂=0.0739 for 9808 reflections with I>2σ(I) and R₁=0.0330 and wR₂=0.0748 for all data with S=1.049 and residual electron density, ρ_{max/min}=0.642 and −0.598 e Å ⁻³. Flack parameter x=−0.005(3) determined using 4130 selected quotients by Parsons' method. The crystals were grown by vapor diffusion in a DCM-diethyl ether system at r.t.

### Crystallographic data for 3b

C₄₃H₅₀CuN₆⁺CF₃O₃S, yellow plank (0.078×0.062×0.025 mm³), formula weight 863.50; orthorhombic, Pca2₁ (No. 29), a=20.1211(2) Å, b=13.39232(18) Å, c=15.13962(18) Å, V=4079.64(9) Å³, Z=4, Z′=1, T=95(2) K, d_{calc}=1.406 g cm⁻³, (CuKα)=1.752 mm¹, F(000)=1808; T_{max/min}=1.000/0.865; 29635 reflections were collected (3.9650°≤θ≤74.769°, index ranges: −24≤h≤25, −16≤k≤16, −18≤1≤18), 8154 of which were unique, Rᵢₙₜ=0.0383, R₁=0.0380; completeness to θₘₐₓ 99.8%. The refinement of 603 parameters with 354 restraints converged to R₁=0.0371 and wR₂=0.1018 for 7899 reflections with I>2σ(I) and R₁=0.0382 and wR₂=0.1029 for all data with S=1.039 and residual electron density, ρ_{max/min}=1.131 and −0.394 e Å⁻³. Flack parameter x=0.16(2); the structure was refined as an inversion twin. The crystals were grown by vapor diffusion in a DCM-diethyl ether system at r.t.

### Crystallographic data for 3c

C₄₃H₅₀CuN₆⁺C₂F₃O₂⁻, light yellow plank (0.131×0.120×0.048 mm³), formula weight 827.45; orthorhombic, Pca2₁ (No. 29), a=19.77529(5) Å, b=13.53091(4) Å, c=15.04125(5) Å, V=4024.70(2) Å³, Z=4, Z′=1, T=93(2) K, d_{calc}=1.366 g cm⁻³, (CuKα)=1.261 mm⁻¹, F(000)=1736; T_{max/min}=1.000/0.626; 74939 reflections were collected (3.266°≤θ≤79.715°, index ranges: −25≤h≤25, −17≤k≤17, −19≤1≤19), 8588 of which were unique, Rᵢₙₜ=0.0367, R₁=0.0188; completeness to θₘₐₓ 99.8%. The refinement of 578 parameters with 218 restraints converged to R₁=0.0253 and wR₂=0.0674 for 8504 reflections with I>2σ(I) and R₁=0.0256 and wR₂=0.0676 for all data with S=1.046 and residual electron density, ρ_{max/min}=0.188 and −0.379 e Å⁻³. Flack parameter x=0.174(17); the structure was refined as an inversion twin. The crystals were grown by vapor diffusion in a DCM-diethyl ether system at r.t.

### Crystallographic data for 3d

C₄₃H₅₀CuN₆⁺C₂₄H₂₀B⁻×0.175 C₄H₁₀O×0.825 C₃H₆O, yellow prism (0.166×0.129×0.076 mm³), formula weight 1094.52; orthorhombic, Pbca (No. 61), a=19.42866(14)Å, b=20.15442(13) Å, c=30.18361(19) Å, V=11819.09(14) Å³, Z=8, Z′=1, T=100(2) K, d_{calc}=1.230 g cm⁻³, (CuKα)=0.894 mm⁻¹, F(000)=4654; T_{max/min}=1.000/0.666; 71255 reflections were collected (2.928°≤θ≤77.389°, index ranges: −24≤h≤24, −19≤k≤25, −29≤1≤38), 12385 of which were unique, Rᵢₙₜ=0.0347, Rₒ=0.0248; completeness to θₘₐₓ 98.6%. The refinement of 768 parameters with 119 restraints converged to R₁=0.0356 and wR₂=0.0948 for 11080 reflections with I>2σ(I) and R₁=0.0398 and wR₂=0.0976 for all data with S=1.041 and residual electron density, ρ_{max/min}=0.328 and −0.657 e Å⁻³. The crystals were grown by vapor diffusion in an acetone-diethyl ether system at r.t.

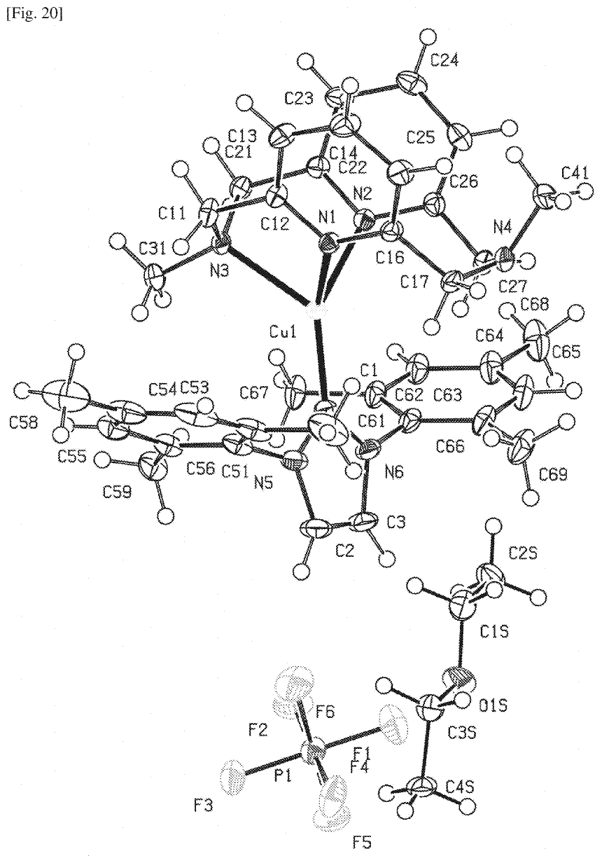

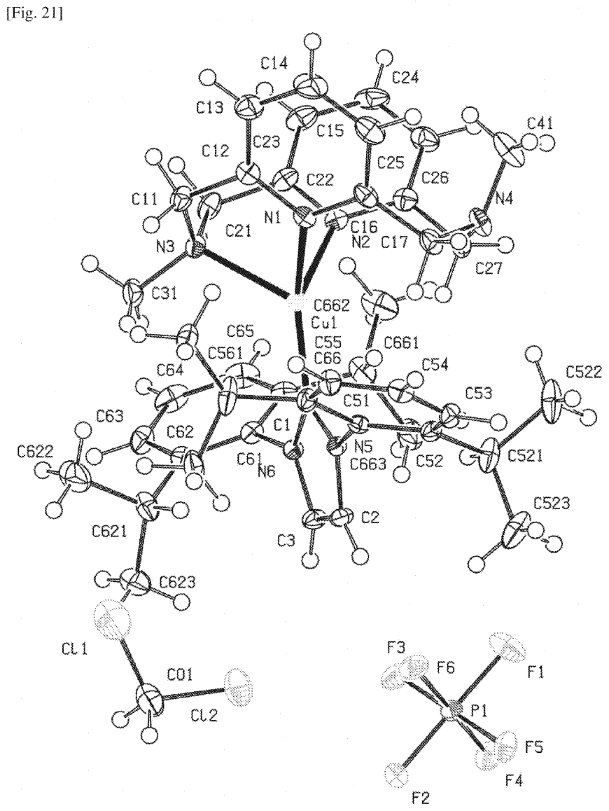

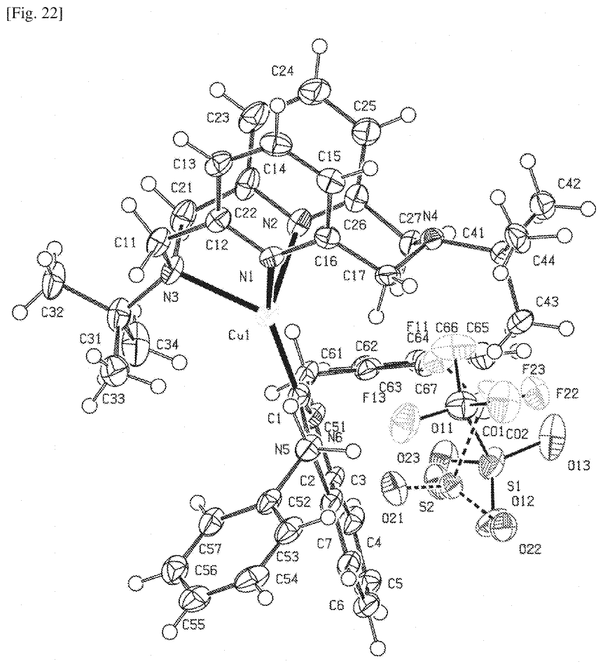

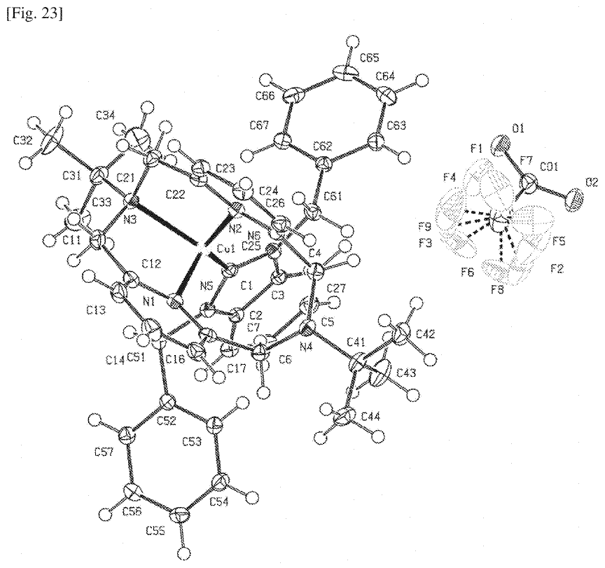

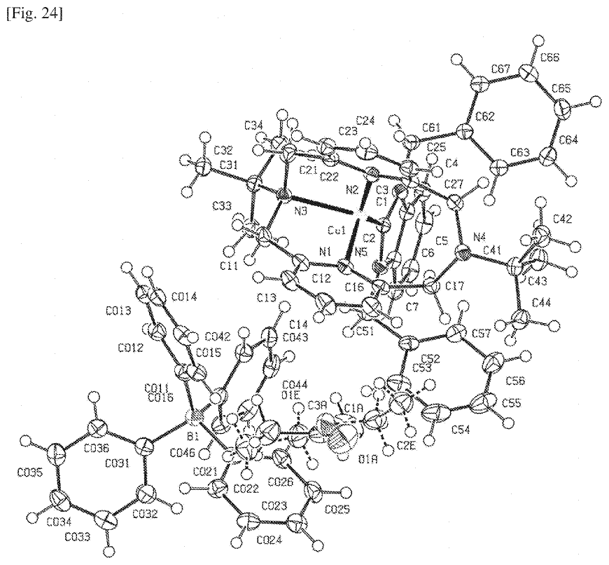

See FIG. 20 to 24.

### VI. REFERENCES

1. N. I. Korotkikh, V. S. Saberov, A. V. Kiselev, N. V. Glinyanaya, K. A. Marichev, T. M. Pekhtereva, G. V. Dudarenko, N. A. Bumagin, O. P. Shvaika, Chem. Heterocycl. Compd. (N. Y.) 2012, 47, 1551-1560.
2. F. Bottino, M. Di Grazia, P. Finocchiaro, F. R. Fronczek, A. Mamo, S. Pappalardo, J. Org. Chem. 1988, 53, 3521-3529.
3. C.-M. Che, Z.-Y. Li, K.-Y. Wong, C.-K. Poon, T. C. W. Mak, S.-M. Peng, Polyhedron 1994, 13, 771-776.
4. A. Karimata, P. H. Patil, E. Khaskin, S. Lapointe, R. R. Fayzullin, P. Stampoulis, J. R. Khusnutdinova, Chem. Commun. 2020, 56, 50-53.
5. G. Sheldrick, Acta Crystallogr., Sect. A 2015, 71, 3-8.
6. G. Sheldrick, Acta Crystallogr., Sect. C 2015, 71, 3-8.
7. L. J. Farrugia, J. Appl. Crystallogr. 2012, 45, 849-854.
8. S. Parsons, H. D. Flack, T. Wagner, Acta Crystallogr., Sect. B: Struct. a counter anion using in the invention is useful as the tribolumi Sci., Cryst. Eng. Mater. 2013, 69, 249-259.

### INDUSTRIAL APPLICABILITY

The Cu complex with an N-heterocyclic carbene ligand, a pyridinophane ligand and a counter anion using in the invention is useful as the triboluminescent material, and is easily available because the central metal is Cu. By using the triboluminescent material comprising the Cu complex, an inexpensive sensor is capable to be provided.

1. A triboluminescent material comprising a Cu complex with an N-heterocyclic carbene ligand, a pyridinophane ligand and a counter anion.

2. The triboluminescent material according to claim 1, wherein the Cu complex is represented by the following formula (1): 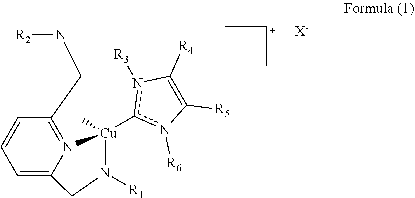
wherein R₁ and R₂ each represent a hydrogen atom or a substituent having 50 or less carbon atoms, R₃ to R₆ each represent a hydrogen atom or a substituent, any pair of R₃ to R₆ are optionally taken together to form a ring, and at least one of the two pyridine rings is optionally substituted X⁻ represents a counter anion.

3. The triboluminescent material according to claim 2, wherein R₁ and R₂ are different from each other.

4. The triboluminescent material according to claim 2, wherein R₁ and R₂ each represent a hydrocarbon group having 1 to 50 carbon atoms.

5. The triboluminescent material according to claim 2, wherein R₄ and R₅ are taken together to form a ring.

6. The triboluminescent material according to claim 1, which is free from polymers.

7. The triboluminescent material according to claim 1, which comprises a polymer.

8. The triboluminescent material according to claim 7, wherein the Cu complex is not covalently incorporated into the polymer.

9. The triboluminescent material according to claim 7, wherein the Cu complex is covalently incorporated into the polymer.

10. The triboluminescent material according to claim 7, which comprises a crystalline fragment of the Cu complex.

11. The triboluminescent material according to claim 7, which is in a form of a film.

12. In a method of use of a triboluminescent material, the improvement wherein said triboluminescent material is a Cu complex with an N-heterocyclic carbene ligand, a pyridinophane ligand and a counter anion.

13. In a method of use of a triboluminescent material, the improvement wherein said triboluminescent material is a composition comprising a polymer and a Cu complex with an N-heterocyclic carbene ligand, a pyridinophane ligand and a counter anion.

14. A mechanoresponsive sensor comprising the triboluminescent material of claim 1.

15. A method for detecting a mechanical loading or mechanical damage comprising:
determining a mechanoresponse of the mechanochemical material according to claim 1 to the mechanical loading.

16. A method for preparing the triboluminescent material according to claim 7, comprising:
dissolving the Cu complex and the polymer in a solvent to prepare a solution, and
drying the solution.

17. A triboluminescent material prepared by the method according to claim 16.

18. A method for designing a Cu complex, comprising:
1) evaluating triboluminescence of a Cu complex with an N-heterocyclic carbene ligand, a pyridinophane ligand and a counter anion, and
2) modifying at least one of the N-heterocyclic carbene ligand, the pyridinophane ligand and the counter anion to so design a new Cu complex as to improve triboluminescent property, and
3) optionally repeating 2) at least once.

19. A program for designing a Cu complex, performing the method according to claim 18.
